(19) United States
(12) Patent Application Publication
(10) Pub. No.: US 2014/0093804 A1
(43) Pub. Date: Apr. 3, 2014

(54) METAL-HALOGEN FLOW BATTERY WITH SHUNT CURRENT INTERRUPTION AND SEALING FEATURES

(71) Applicant: PRIMUS POWER CORPORATION, Hayward, CA (US)

(72) Inventors: Paul Kreiner, San Francisco, CA (US); Kyle Haynes, Redwood City, CA (US); Jonathan Hall, San Mateo, CA (US); Lauren Hart, San Francisco, CA (US); Rick Winter, Orinda, CA (US); Russell Cole, San Francisco, CA (US); Pallavi Pharkya, Fremont, CA (US)

(73) Assignee: Primus Power Corporation, Hayward, CA (US)

(21) Appl. No.: 13/630,617

(22) Filed: Sep. 28, 2012

(51) Int. Cl. H01M 8/04; H01M 8/18; H01M 8/22

(52) U.S. Cl. CPC H01M 8/04276; H01M 8/22; H01M 8/184
USPC 429/455; 429/458; 429/460

(57) ABSTRACT

A flow battery includes a stack of flow cells, a stack of cell frames supporting the stack of cells, stack level and cell level flow manifolds located in the stack of cell frames, and at least one sealing or shunt current mitigation feature.

### FIELD

The present invention is directed to electrochemical systems, such as flow batteries, and methods of using same.

### BACKGROUND

The development of renewable energy sources has revitalized the need for large-scale batteries for off-peak energy storage. The requirements for such an application differ from those of other types of rechargeable batteries such as lead-acid batteries. Batteries for off-peak energy storage in the power grid generally are required to be of low capital cost, long cycle life, high efficiency, and low maintenance.

One type of electrochemical energy system suitable for such an energy storage is a so-called “flow battery” which uses a halogen component for reduction at a normally positive electrode, and an oxidizable metal adapted to become oxidized at a normally negative electrode during the normal operation of the electrochemical system. An aqueous metal halide electrolyte is used to replenish the supply of halogen component as it becomes reduced at the positive electrode. The electrolyte is circulated between the electrode area and a reservoir area. One example of such a system uses zinc as the metal and chlorine as the halogen.

### SUMMARY

An embodiment relates to a flow battery which includes a stack of flow cells, a stack of cell frames supporting the stack of cells, stack level and cell level flow manifolds located in the stack of cell frames, and at least one sealing or shunt current mitigation feature. Another embodiment relates to a method of operating the flow battery.

### BRIEF DESCRIPTION OF THE DRAWINGS

FIG. 1 illustrates a side cross sectional view of an embodiment of the electrochemical system with a sealed container containing a stack of electrochemical cells.

FIG. 2A illustrates a schematic side cross sectional view of flow paths in the embodiment electrochemical system.

FIGS. 2B and 2C illustrate schematic side cross sectional views of flow paths in the flow battery cells of the system of FIG. 2A.

FIG. 3A is a plan view of an upper side of a cell frame for holding the horizontally positioned cells illustrated in FIGS. 2A-2C.

FIG. 3B is a plan view of a lower side of the cell frame illustrated in FIG. 3A.

FIGS. 3C-3E are respective three dimensional top and bottom views illustrating details of the stack of flow battery cells of the embodiment system of FIG. 2A.

FIG. 3F schematically illustrates a shunt current resistor network in the flow battery stack of FIGS. 1 to 3D.

FIG. 4 is a top view of a serpentine cell manifold in a cell frame according to an embodiment.

FIG. 5A is an exploded view, FIG. 5B is a three dimensional perspective view and FIG. 5C is partially transparent top view through the impermeable electrode of an electrode-to-electrolyte interface area of the cell frame of FIG. 4.

FIG. 6 is an exploded view of a compliant cover in a stack of flow cells according to an embodiment.

FIG. 7 is a three dimensional cut away view of the stack of FIG. 6.

FIG. 8 is an exploded view of the stack with a solid cover according to an embodiment.

FIGS. 9A and 9B are three dimensional cut away views along lines A-A and B-B, respectively, in FIG. 8.

FIGS. 10-11 illustrate schematic side cross sectional view of flow paths in the electrochemical system of alternative embodiments.

FIG. 12 is a three dimensional exploded view of a stack with a sleeve seal according to an embodiment.

FIG. 13A-13H illustrate a schematic side cross sectional views of flow paths in alternative embodiment electrochemical systems.

### DETAILED DESCRIPTION

Embodiments of the present invention are drawn to metal halogen electrochemical system (also sometimes referred to as a “flow battery”) and methods of operating such flow batteries with reduced or minimized shunt currents and their effects, reduced fluidic resistance and pumping losses, and improved ease of battery assembly and greater reliability of seals.

Flow Battery System

The electrochemical (e.g., flow battery) system can include a vessel containing one or more electrochemical cells (e.g., a stack of flow battery cells) in its inner volume, a metal-halide electrolyte, and a flow circuit configured to deliver the metal-halide electrolyte to the electrochemical cell(s). The flow circuit may be a closed loop circuit that is configured to deliver the electrolyte to and from the cell(s). In many embodiments, the loop circuit may be a sealed loop circuit.

Each of the electrochemical cell(s) may comprise a first, fluid permeable electrode, which may serve as a positive electrode, a second, fluid impermeable electrode, which may serve as a negative electrode, and a reaction zone between the electrodes. The first electrode may be a porous electrode or contain at least one porous element. The first electrode may comprise a porous or a permeable carbon, metal or metal oxide electrode. For example, the first electrode may comprise porous carbon foam, a metal mesh or a porous mixed metal oxide coated electrode, such as a porous titanium electrode coated with ruthenium oxide (i.e., ruthenized titanium). In discharge and charge modes, the first electrode may serve as a positive electrode at which the halogen may be reduced into halogen ions. The second electrode may comprise a primary depositable and oxidizable metal, i.e., a metal that may be oxidized to form cations during the discharge mode. For example, the second electrode may comprise a metal that is of the same type as a metal ion in one of the components of the metal halide electrolyte. For example, when the metal halide electrolyte comprises zinc halide, such as zinc chloride or zinc bromide, the second electrode may comprise metallic zinc. Alternatively, the second electrode may comprise another material, such as titanium that is plated with zinc.

Preferably, the reaction zone lacks a separator and the electrolyte circulates through the same flow path (e.g., single loop) without a separation between the electrodes in each cell. In other words, the reaction zone may be such that it does not contain a membrane or a separator between the positive and negative electrodes of the same cell that is impermeable to the halogen ions in the electrolyte. Furthermore, the cell may be a hybrid flow battery cell rather than a redox flow battery cell. Thus, in the hybrid flow battery cell, a metal, such as zinc is plated onto one of the electrodes, the reaction zone lacks an ion exchange membrane which allows ions to pass through it (i.e., there is no ion exchange membrane between the cathode and anode electrodes) and the electrolyte is not separated into a catholyte and anolyte by the ion exchange membrane. The electrolyte is stored in one reservoir rather than in separate catholyte and anolyte reservoirs.

Preferably, the electrochemical system may be reversible, i.e., capable of working in both charge and discharge operation mode. The reversible electrochemical system usually utilizes at least one metal halide in the electrolyte, such that the metal of the metal halide is sufficiently strong and stable in its reduced form to be able to form an electrode. The metal halides that can be used in the reversible system include zinc halides, as element zinc is sufficiently stable to be able to form an electrode. Preferably, the electrolyte is aqueous solution of at least one metal halide electrolyte compound, such as ZnBr₂ and/or ZnCl₂. For example, the solution may be a 15-50% aqueous solution of ZnBr₂ and/or ZnCl₂, such as a 25% solution. In certain embodiments, the electrolyte may contain one or more additives, which can enhance the electrical conductivity of the electrolytic solution. For example, when the electrolyte contains ZnCl₂, such additive can be one or more salts of sodium or potassium, such as NaCl or KCl. When the electrolyte contains ZnBr₂, then the electrolyte may also contain a bromine complexing agent, such as such as a quaternary ammonium bromide (QBr), such as N-ethyl-N-methyl-morpholinium bromide (MEM), N-ethyl-N-methyl-pyrrolidinium bromide (MEP) or Tetra-butyl ammonium bromide (TBA)).

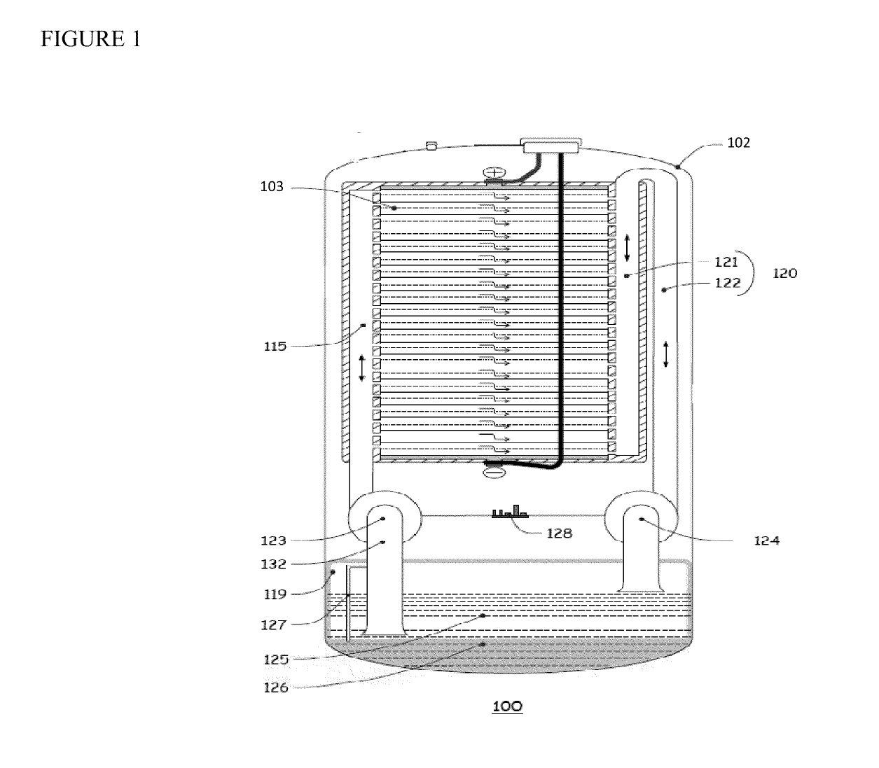

FIG. 1 illustrates an electrochemical system 100 which includes a stack of flow battery cells in a sealed container 102. The flow battery cells inside the sealed container 102 are preferably a horizontally positioned cell, which may include a horizontal positive electrode and horizontal negative electrode separated by a gap. For example, element 103 in FIG. 1 represents a vertical stack of horizontally positioned electrochemical cells (i.e., flow cells) connected electrically in series.

As shown in FIG. 1 a feed (e.g., inlet) conduit (e.g., pipe or manifold 115) is configured to deliver the metal-halide electrolyte to the horizontally positioned cells of the stack 103. A return (e.g., outlet) conduit (e.g., pipe or manifold) 120 is configured to collect products of an electrochemical reaction from cells of the stack. The return pipe or manifold 120 may be an upward-flowing return pipe or manifold. The pipe or manifold 120 includes an upward running section 121 and a downward running section 122. The flow of the metal-halide electrolyte and the concentrated halogen reactant leaves the cells of the stack 103 upward through the section 121 and then goes downward to the reservoir through the section 122. As will be discussed in more detail below, in some embodiments, the feed pipe or manifold and/or the return pipe or manifold may be a part of a stack assembly for the stack of the horizontally positioned cells. In some embodiments, the stack 103 may be supported directly by walls of the vessel 102. Yet in some embodiments, the stack 103 may be supported by one or more pipes, pillars or strings connected to walls of the vessel 102 and/or reservoir 119.

The flow battery system may include one or more pumps for pumping the metal-halide electrolyte. Such a pump may or may not be located within the inner volume of the sealed vessel. For example, FIG. 1 shows discharge pump 123, which fluidly connects the reservoir 119 and the feed pipe or manifold 115. The pump 123 is configured to deliver the metal-halide electrolyte through the feed pipe or manifold 115 to the stack of flow battery cell(s) 103. In some embodiments, the flow battery system may include an optional additional pump 124. The pump 124 fluidly connects the return pipe or manifold 120 to the reservoir 119 and can be used to deliver the metal-halide electrolyte through the return pipe or manifold to the stack of cell(s) in charge and/or discharge mode. Alternatively, pump 124 may be omitted and the system may comprise a single flow loop/single pump flow battery system. Any suitable pumps may be used in the system, such as centripetal and/or centrifugal pumps.

The reservoir 119 may contain a feed line 127 for the concentrated halogen reactant, which may supply the halogen reactant to the feed pipe or manifold 115 of the system. As used herein, a “concentrated halogen reactant” includes aqueous electrolyte with higher than stoichiometric halogen content (e.g., higher halogen content than 1:2 zinc to halogen ratio for zinc-halide electrolyte), pure liquid halogen (e.g., liquid chlorine and/or bromine) or chemically-complexed halogen, such as a bromine-MEP or another bromine-organic molecule complex. A connection between the halogen reactant feed line 127 and the feed pipe manifold 115 may occur before, at or after the pump 123. An inlet of the feed line 127 is located in the lower part 126 of the reservoir 119, where the complexed bromine reactant may be stored. An outlet of the feed line 127 is connected to an inlet of the pump 123. The electrolyte intake feed line, such as a pipe or conduit 132, is located in the upper part 125 of the reservoir 119, where the lighter metal-halide electrolyte (e.g., aqueous zinc bromide) is located.

In some embodiments, the electrochemical system may include a controlling element, which may be used, for example, for controlling a rate of the pump(s). Such a controlling element may be an analog circuit. FIG. 1 depicts the controlling element as element 128.

Flow Configurations

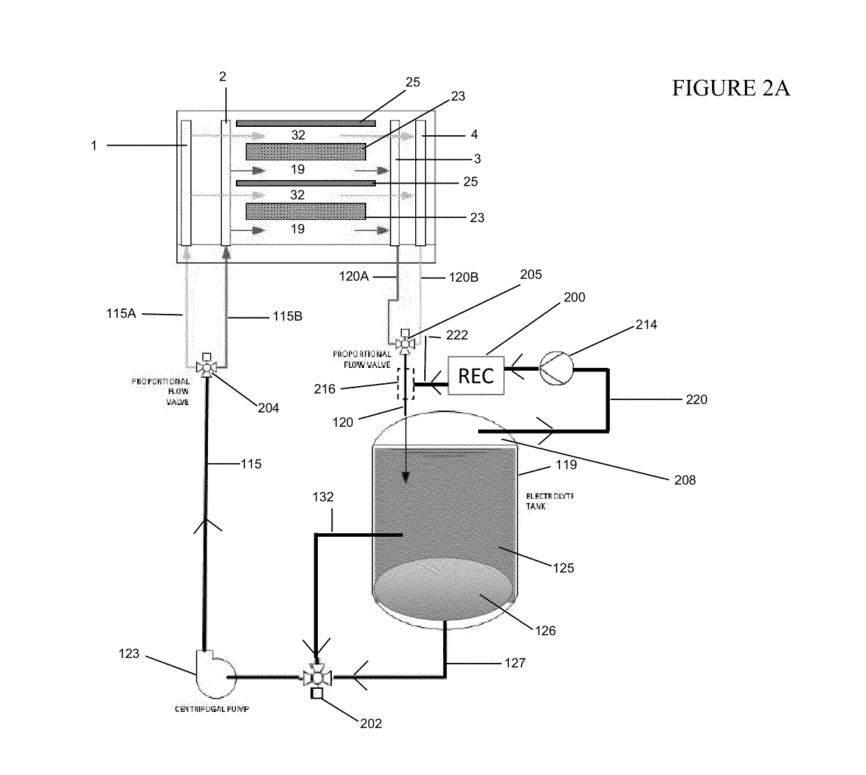

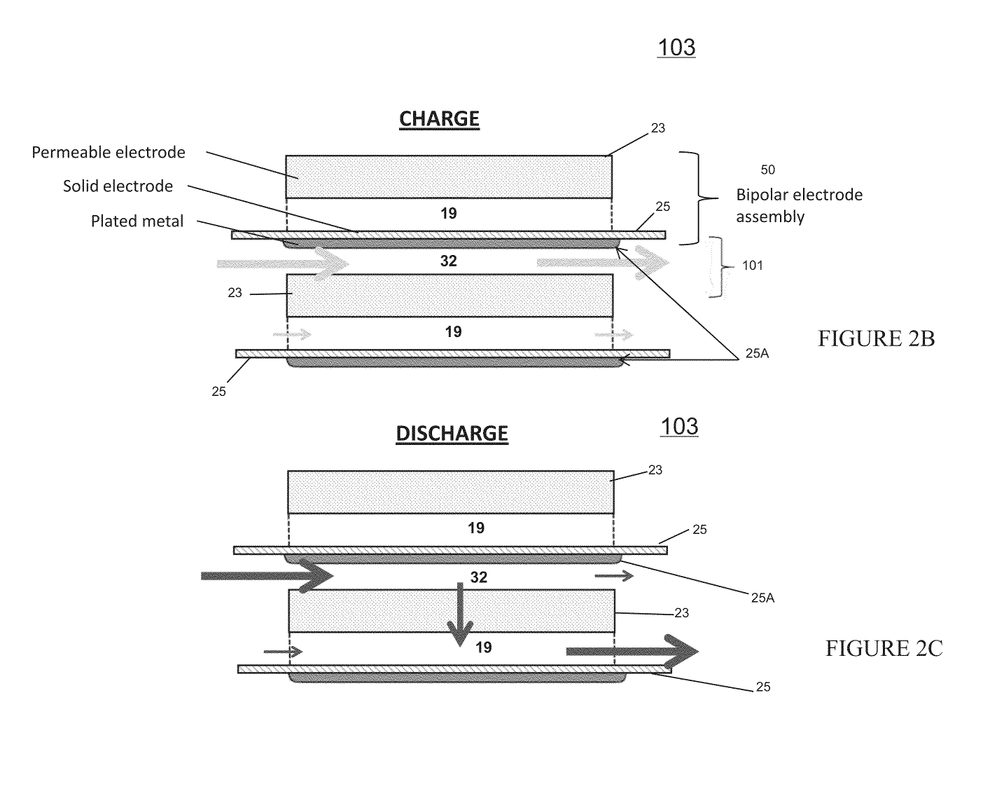

FIGS. 2B and 2C schematically illustrate respective charge mode and discharge mode paths for a flow of the metal-halide electrolyte and the halogen reactant through the horizontally positioned cells of the stack, such as the stack 103 of FIGS. 1 and 2A. The electrolyte flow paths in FIGS. 2A-2C are represented by arrows. The reservoir 119 may contain one or more internal liquid portions as well as one or more internal gaseous portions. In this embodiment, the reservoir 119 includes two liquid portions 125 and 126, and one gaseous portion 208. Gaseous species, such as halogen (e.g. Cl₂ or Br₂) and hydrogen gas, are stored in the upper portion 208 (e.g., head space) of the reservoir 119. The reservoir 119 may also include internal structures or filters (not shown for clarity). A liquid pump (e.g., centrifugal pump 123) may be used to pump the electrolyte from upper liquid portion 125 of the reservoir 119 via conduit 132 which has an inlet in portion 125 of the reservoir. Conduit 127 has an inlet in the lower liquid portion 126 of the reservoir 119 where the majority of the concentrated halogen reactant is located. In charge mode, conduit 127 is closed by valve 202 such no concentrated halogen reactant flows into the stack 103 via conduit 127 during charge mode. In discharge mode, valve 202 is open to allow halogen reactant to flow into the stack 103 via conduit 127.

Each flow battery cell 101 in the stack 103 includes a porous (e.g., fluid permeable) electrode 23 and a non-porous (e.g., fluid impermeable) electrode 25. As described above, the permeable electrode 23 may be made of any suitable material, such as a titanium sponge or mesh. The impermeable electrode 25 may be made of any suitable material, such as titanium. A layer of metal 25A, such as zinc, is plated on the impermeable electrode 25 (e.g., on the bottom surface of electrode 25), as shown in FIGS. 2B and 2C. The reaction zone 32 is located between and separates the impermeable electrode 25/layer of metal 25A and the permeable electrode 23.

FIG. 2B illustrates the flows through the stack 103 of FIG. 2A during charge mode. In the charge mode, aqueous halogen electrolyte is pumped by the pump 123 from the upper liquid portion 125 of the reservoir 119 through conduit 132 into conduit 115. Conduit 115 contains a first flow valve, such as a proportional three way valve 204. Valve 204 may be a computer controlled valve. The valve sends a majority (e.g., 51-100%, such as 60-95%, including 70-90%) of the electrolyte into conduit 115A, and a minority (e.g., 0-49%, such as 5-40%, including 10-30%) of the electrolyte (including no electrolyte) into conduit 115B. Conduit 115A is fluidly connected to the first stack inlet manifold 1 and conduit 115B is fluidly connected to the second stack inlet manifold 2, as will be described in more detail below.

The first stack inlet manifold 1 provides the major portion of the electrolyte to the reaction zone 32 of each cell 101, while the second stack inlet manifold 2 provides a minority of the electrolyte (or no electrolyte) to the space (e.g., one or more flow channels) 19 between the cells 101 located between the permeable electrode 23 of a first cell 101 and an impermeable electrode 25 of an adjacent second cell 101 located below the first cell in the stack 103. The electrodes 23, 25 of adjacent cells may be connected to each other to form a bipolar electrode assembly 50 as will be described in more detail below. Metal, such as zinc, plates on the bottom of the impermeable electrode 25 forming a metal layer 25A in the reaction zone 32. Halogen ions (such as chloride or bromide) in the aqueous electrolyte oxidize to form a diatomic halogen molecule (such as Cl₂, Br₂) on the permeable electrode 23.

The majority of the electrolyte flows through the reaction zone 32 and exits into first stack outlet manifold 3. The minority of the electrolyte (or no electrolyte) flowing in the flow channel(s) 19 between the cells 101 exits into the second stack outlet manifold 4.

Manifold 3 provides the electrolyte into conduit 120A while manifold 4 provides the electrolyte into conduit 120B. Conduits 120A and 120B converge at a second flow valve, such as a proportional three way valve 205. Valve 205 may be a computer controlled valve. Valve 205 is connected to the outlet conduit 120 and controls the electrolyte flow volume into conduit 120 from conduits 120A and 120B. Conduit 120 provides the electrolyte back into the upper liquid portion 25 of the reservoir 119.

Thus, in the charge mode, the metal halide electrolyte is pumped by pump 123 from the reservoir 119 through an inlet conduit (e.g., one or more of flow pathways 132, 115, 115A, 1) to the reaction zone 32 of each flow cell 101 in the stack 103 in one direction (e.g., left to right in FIG. 2B). A majority of the metal halide electrolyte enters the reaction zone 32 from the inlet conduit (e.g., from manifold 1 portion of the inlet conduit) without first flowing through the permeable electrode 23 in the flow cell 101 or through the flow channel 19 located between adjacent flow cell electrodes 23, 25 in the stack 103. The metal halide electrolyte then flows from the reaction zone 32 of each flow cell in the stack through an outlet conduit (e.g., one or more of flow pathways 3, 120A, 120) to the reservoir 119, such that the majority of the metal halide electrolyte does not pass through the permeable electrode 23 in each flow cell 101 before reaching the outlet conduit (e.g., manifold 3 portion of the outlet conduit).

FIG. 2C illustrates the flows through the stack 103 of FIG. 2A during discharge mode. In discharge mode, valve 202 in conduit 127 is opened, such that the aqueous electrolyte and concentrated halogen reactant (e.g., complexed bromine) are pumped by pump 123 from the respective middle portion 125 and the lower liquid portion 126 of the reservoir 119 to respective conduits 132 and 127.

The electrolyte and the concentrated halogen reactant are provided from respective regions 125 and 126 of the reservoir 119 via conduits 132 and 127. The mixture flows from conduit 115 via valve 204 and conduit 115A and optionally conduit 115B to respective inlet manifolds 1 and 2. As in the charge mode, the majority of the electrolyte and concentrated halogen reactant mixture flows into the inlet manifold 1 and a minority of the mixture (or no mixture) flows into the inlet manifold 2.

The electrolyte and concentrated halogen reactant (e.g., complexed bromine) mixture enters the reaction zone 32 from manifold 1. In other words, the mixture enters the cell reaction zone 32 between the electrodes 23, 25 from the manifold without first passing through the permeable electrode 23. Since the complexed bromine part of the mixture is heavier than the electrolyte, the complexed bromine flows through the permeable electrode 23 at the bottom of each cell 101. In the discharge mode, complexed bromine passing through the permeable electrode 23 is reduced by electrons, resulting in the formation of bromine ions. At the same time, the metal layer 25A on the impermeable electrode 25 is oxidized, resulting in metal (e.g., zinc) ions going into solution in the electrolyte. Bromine ions formed in the discharge step are provided into the flow channel(s) 19 between the cells 101, and are then provided from the flow channel(s) 19 through the second stack outlet manifold 4 into conduit 120B. The electrolyte rich in zinc ions is provided from the reaction zone 32 through the first stack outlet manifold 3 into conduit 120A. The bromine ions in conduit 120B and the zinc rich electrolyte in conduit 120A are mixed in valve 205 and then provided via conduit 120 back to the middle portion 125 of the reservoir.

Thus, in the discharge mode, the mixture of the metal halide electrolyte and the concentrated halogen reactant (e.g., complexed bromine) flows from the reservoir 119 through the inlet conduit (e.g., one or more of flow pathways 132, 115, 115A, 1) to the reaction zone 32 of each flow cell 101 in the stack 103 in the same direction as in the charge mode (e.g., left to right in FIG. 2C). A majority of the mixture enters the reaction zone 32 from the inlet conduit without first flowing through the permeable electrode 23 in the flow cells 101 or through the flow channel 19 located between adjacent flow cell 101 electrodes 23, 25 in the stack 103. The mixture then flows from the reaction zone 32 of each flow cell 101 in the stack 103 through the outlet conduit (e.g., one or more of flow pathways 3, 120A, 120) to the reservoir 119, such that a majority of the mixture passes through the permeable electrode 23 in each flow cell 101 before reaching the outlet conduit (e.g., the manifold 3 portion of the outlet conduit).

Thus, in charge mode, the majority of the flow is “flow-by” (e.g., the majority of the liquid flows by the permeable electrode through the reaction zone), while in discharge mode, the majority of the flow is “flow-through” (e.g., the majority of the liquid flows through the permeable electrode from the reaction zone) due to the difference in the reaction kinetics in charge and discharge modes.

Valves 204 and/or 205 may be used control the ratio of liquid flow rate between the two inlet paths (e.g., 115A/115B) and/or between the two outlet paths (e.g., 120A/120B). Thus, the net amount of liquid that flows through the permeable electrode 23 may be controlled in charge and/or discharge mode. For example, in charge mode, the valve 205 may be adjusted to provide a higher liquid flow rate through manifold 3 and conduit 120A and a lower liquid flow rate through manifold 4 and conduit 120B to favor the “flow-by” flow configuration. In contrast, in discharge mode, the valve 205 may be adjusted to provide a lower liquid flow rate through manifold 3 and conduit 120A and a higher liquid flow rate through manifold 4 and conduit 120B compared to the charge mode to favor the “flow-through” flow configuration.

In charge mode, the majority of the flow is “flow-by” because this is preferable for the metal plating reaction and sufficient for the halogen oxidation reaction. For the metal plating reaction, it is important to maintain an adequate concentration of metal ions (e.g. Zn²⁺) near the surface of the impermeable electrode 25 onto which the metal layer 25A will be plated. Insufficient flow speed at the exit end of the plating area (which might occur in the “flow-through” arrangement used during discharge) could lead to metal ion starvation and poor plating morphology, particularly at high stack open current when the bulk concentration of metal ions is at its lowest. The halogen oxidation reaction that takes place on the permeable electrode 23 (e.g. bromide ions oxidized to bromine) in the charge mode can be adequately supplied with reactants in either a “flow-by” or a “flow-through” arrangement.

In contrast, in the discharge mode, the majority of the flow is “flow-through” because this is sufficient for the metal layer 25A de-plating reaction and preferable for the halogen reduction reaction. The reactant in the metal de-plating reaction (i.e., zinc layer 25A) is already available along the entire surface of the impermeable electrode 25, where it was plated during the charge mode. As a result, both “flow-by” and “flow-through” are adequate to support this reaction. For the halogen reduction reaction (e.g. bromine reducing to bromide ions), it is important to supply an adequate concentration of halogen to the active surface of the permeable electrode 23. The molecular halogen is not as mobile as its ionic counterpart, particular if a complexing agent is used, so much more surface area and reactant flow rate is needed to support the halogen reduction reaction than the halogen oxidation reaction. Flowing through the permeable electrode 23 achieves this reactant supply requirement.

Thus, charge and discharge inlet flows no longer need to flow on opposite sides of the cell frame and/or in opposite directions. Rather, the same first stack inlet manifold 1 and the same pump 123 may be used to supply the majority of the flow to the reaction zone 32 during both charge and discharge modes. Thus, the majority of the liquid in both the charge and discharge mode flows in the same direction through the reaction zone in both modes and the majority of the liquid in both the charge and discharge mode enters the reaction zone 32 directly from the inlet manifold 1 without first flowing through the permeable electrode 23 or the flow channel(s) 19 between the cells 101. Thus, manifold 1 may be referred to as the “main inlet manifold.”

If desirable, the second stack inlet manifold 2 may be used to supply a minority of the flow through the flow channel(s) 19 between the opposite electrodes 23, 25 of adjacent flow cells 101 to the bottom side of the permeable electrode 23 (i.e., the side of electrode 23 facing the flow channel(s) 19) during charge and/or discharge modes. These charge mode electrolyte purge flow and/or discharge mode electrolyte—complexed bromine mixture purge flow may be useful to prevent bubbles or denser complex phase liquid from accumulating beneath the permeable electrode 23 in the flow channel(s). Thus, the second stack inlet manifold may be referred to as the “secondary inlet manifold” or the “purge inlet manifold”. The purge flows flow from the channel(s) 19 to the second stack outlet manifold 4. Alternatively, the second stack inlet manifold 2 and conduit 115B may be omitted to simplify the overall system design.

The flow battery system of FIG. 2A may also include an optional recombinator 200 and a gas pump 214. The recombinator is a chamber containing a catalyst which promotes or catalyzes recombination of hydrogen and halogen, such as bromine. The gas pump 214 provides halogen and hydrogen gas from the upper portion 208 of the reservoir 119 via conduit 220 to the recombinator 200. The hydrogen and halogen gases react with each other in the recombinator 200 to form a hydrogen-halogen compound. The hydrogen-halogen compound is then returned to the middle portion (e.g., upper liquid portion) 125 of the reservoir 119 from the recombinator 200 via conduits 222 and 120 by the action of the pump 214.

In another embodiment, the pump 214 is replaced with a venturi injector 216, as shown in FIG. 2A. Thus, the system preferably contains either the pump 214 or the venturi 216, but in some embodiments the system may contain both of them. Thus, the venturi is shown with dashed lines. The hydrogen-halogen compound is drawn from the recombinator 200 into conduit 222 which merges into the venturi injector. The hydrogen-halogen compound mixes with the electrolyte flow being returned from the stack 103 to the reservoir 119 in the venturi injector 206 and the mixture is returned to the reservoir 119 via the return conduit 120.

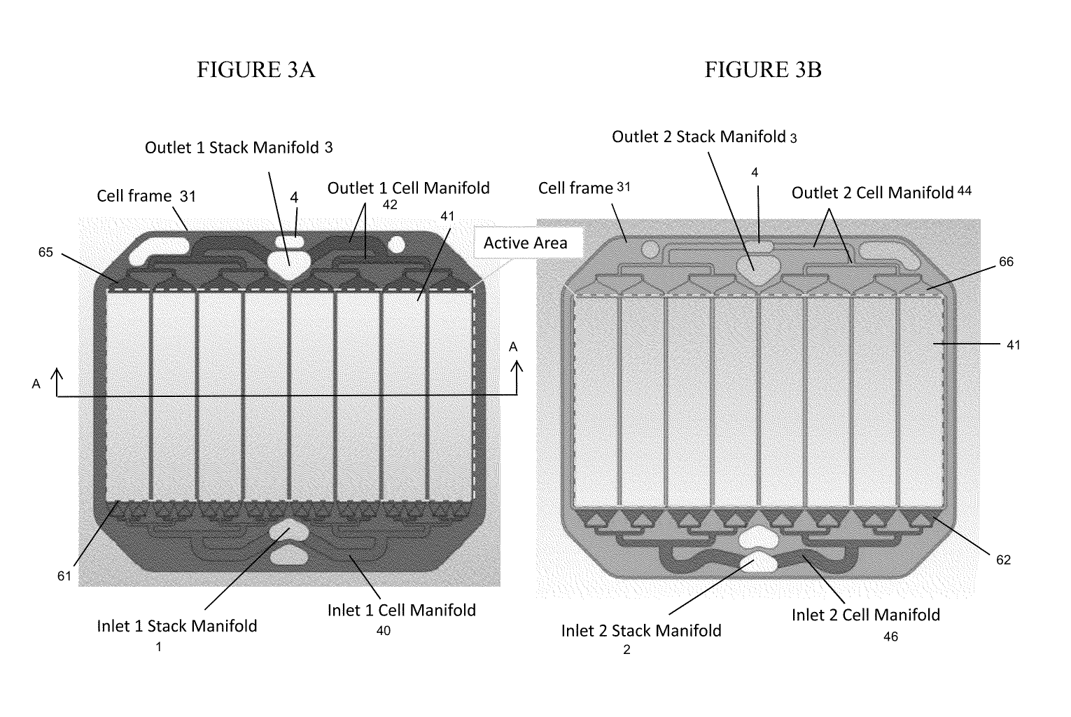

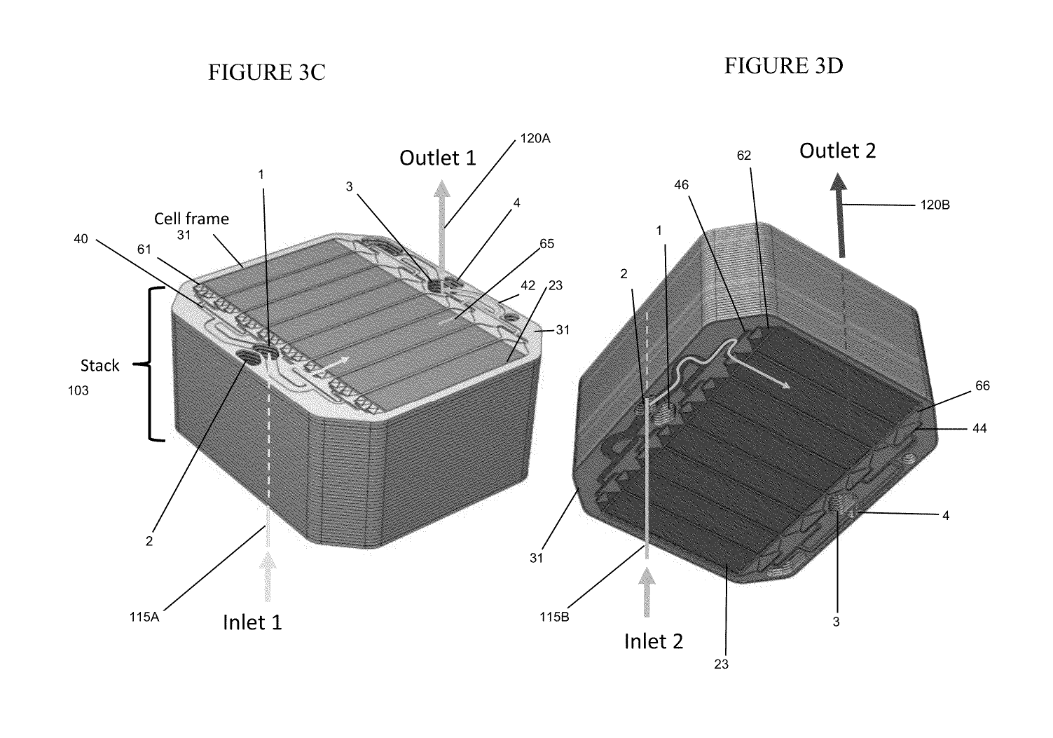

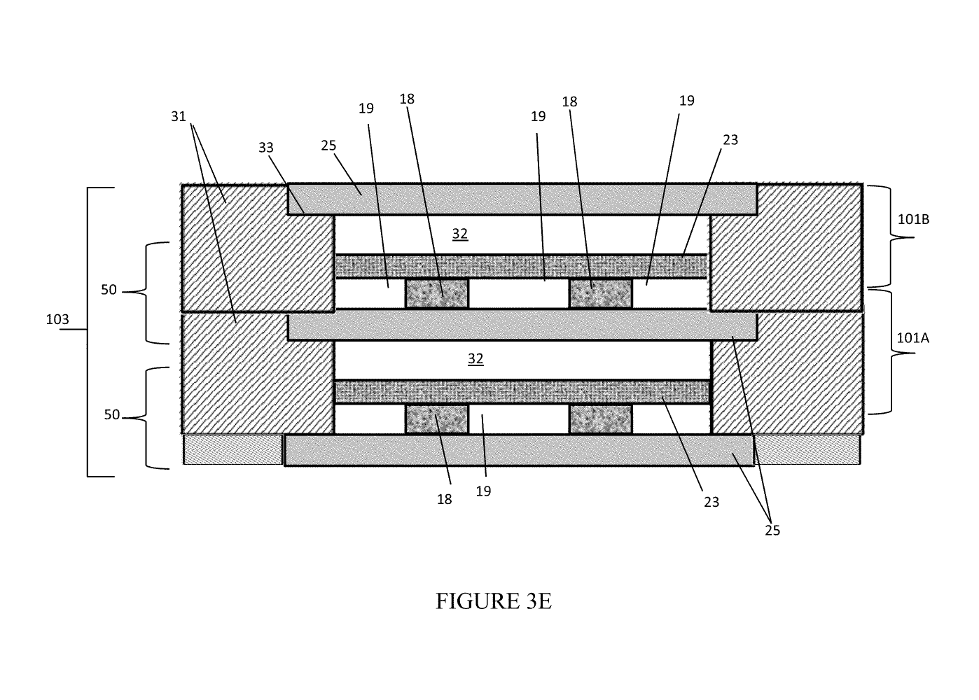

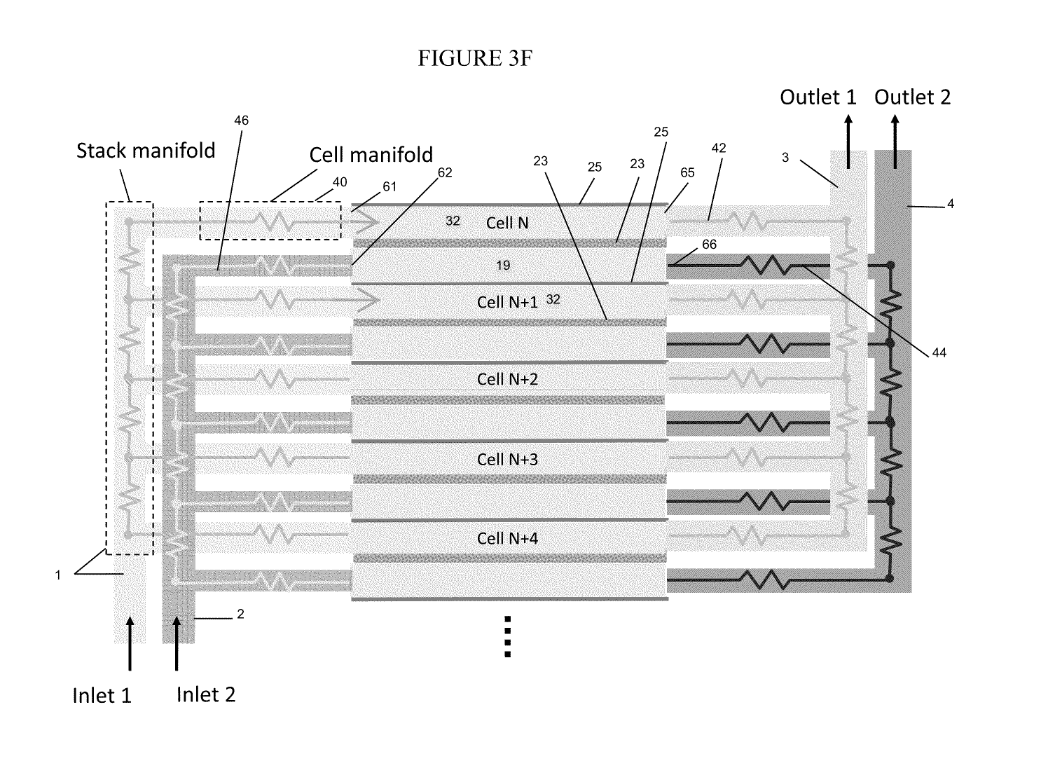

FIGS. 3A and 3B illustrate the features of the top and bottom surfaces, respectively, of a cell frame 31 for holding the horizontally positioned flow battery cells illustrated in FIGS. 1 and 2A-2C. The frame 31 includes the main inlet manifold 1, the secondary inlet manifold 2 and the outlet manifolds 3, 4 described above. The manifolds 1-4 are respective openings through the frame 31 which align with similar openings in other stacked frames 31 to form the manifolds. Thus, the inlet manifolds 1, 2 are formed by aligned inlet manifold openings in the stack of cell frames while the outlet manifolds are formed by aligned outlet manifold openings in the stack of cell frames. The frames also include at least one inlet distribution (e.g., flow) channel and at least one outlet distribution channel. For example, as shown in FIGS. 3A and 3B, the upper and lower surfaces of the frame 31 each contain one inlet distribution channel (e.g., 40 on the upper side and 46 on the lower side) and one outlet distribution channel (e.g., 42 on the upper side and 44 on the lower side). These channels 40-46 comprise grooves in the respective surface of the frame 31. The distribution (e.g., flow) channels 40, 42, 44, 46 are connected to the active area 41 (e.g., opening in middle of frame 31 containing the electrodes 23, 25) and to a respective stack inlet or outlet manifold 1, 3, 4 and 2. The inlet distribution channels 40, 46 are configured to introduce the electrolyte from the respective stack inlet manifold 1, 2 to the reaction zone 32 or the flow channel(s) 19, and the outlet distribution channels 42, 44 are configured to introduce the electrolyte from the reaction zone 32 or the flow channel(s) to the respective outlet manifold 3, 4. Since the distribution/flow channels 40-46 deliver the electrolyte to and from each cell, they may also be referred to as the cell manifolds.

The electrolyte flows from the main inlet manifold 1 through inlet flow channels 40 and inlet 61 in the frame 31 to the flow cells 101. As illustrated in FIG. 3A, only the main inlet manifold 1 is fluidly connected to the inlet channels 40 on the top of the frame 31. In the embodiment illustrated in FIG. 3A, the charge mode inlet manifold 1 connects to two flow channels 40 which successively divide into subchannels (i.e., flow splitting nodes where each channel is split into two subchannels two or more times) to provide a more even and laminar electrolyte flow to the electrodes 23, 25. After passing across the electrodes 23, 25, the electrolyte exits the cells from outlet 65 into exit flow channels 42 on an opposite end or side of the frame 31 from the main inlet manifold 1. The electrolyte empties from the exit (i.e., outlet) flow channels 42 to a first stack outlet manifold 3. Exit channels 42 may also comprise flow splitting nodes/subchannels as shown in FIG. 3A.

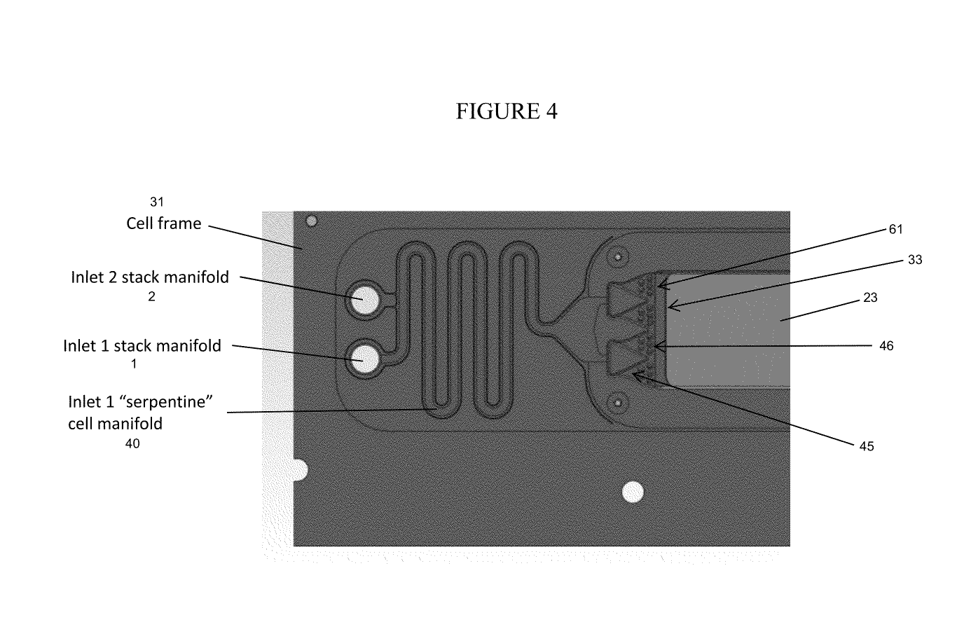

As illustrated in FIG. 3B, on the bottom side of the cell frame 31, the second inlet manifold 2 is connected to bottom purge inlet channels 46 while the main manifold 1 is fluidly isolated from the purge inlet channels 46. While the secondary inlet manifold 2 is shown as being located closer to the edge of the frame 31 than the main manifold 1 in FIGS. 3A and 3B, the positions of the manifolds 1 and 2 may be reversed. Thus, manifold 1 may be located closer to the frame 31 edge than manifold 2, as shown in FIG. 2A or the manifolds 1, 2 may be located side by side, as shown in FIG. 4. The second stack outlet manifold 4 is connected to the electrochemical cells via outlet 66 and bottom exit channels 44 on the bottom surface of the frame 31.

FIGS. 3C and 3D illustrate the flows through the manifolds in the stack of cell frames 31. The stack of cell frames 31 supports the stack 103 of cells 101. The stack of cell frames 31 is preferably a vertical stack in which adjacent cell frames are separated in the vertical direction.

As shown in FIG. 3C, the majority of the liquid flow in the charge and discharge mode flows upward through the main inlet manifold 1 in the frames 31. The flow exits the manifold 1 in each frame to two flow channels 40 which successively divide into subchannels (i.e., flow splitting nodes where each channel is split into two subchannels two or more times). The flow then flows from subchannels 40 through outlet 61 into the reaction zone 32 of each cell. After passing through the reaction zone between the electrodes 23, 25 of each cell 101, the flow exits the cells from outlet 65 into exit flow channels 42 on an opposite end or side of the frame 31 from the main inlet manifold 1. The flow empties from the exit flow channels 42 to the first stack outlet manifold 3. As described above, in discharge mode, a portion of the flow passes through the permeable electrode 23 into the flow channel(s) 19. After passing through the flow channel(s) 19, the flow is provided through outlet 66 into exit flow channels 44. The flow empties from the exit flow channels 44 to the second stack outlet manifold 4.

As shown in FIG. 3D, the minority of the liquid flow (e.g., the purge flow) flows in the charge and discharge mode flows upward through the secondary inlet manifold 2 in the frames 31. The flow exits the manifold 2 in each frame to two flow channels 46 which successively divide into subchannels (i.e., flow splitting nodes where each channel is split into two subchannels two or more times). The flow then flows from subchannels 46 through outlet 62 into the flow channel(s) 19 between each cell 101. After passing through the flow channel(s) 19, the flow is provided through outlet 66 into exit flow channels 44. The flow empties from the exit flow channels 44 to the second stack outlet manifold 4.

As described above with respect to FIGS. 2B and 2C, in charge mode, the purge flow passes through outlets 66 channels 44 to manifold 4. In discharge mode, the majority of the flow passes through the permeable electrode 23 into channel(s) 19 and then through outlet 66 into exit channels 44 and then into manifold 4. Thus, the purge flow may be omitted in discharge mode by adjusting valve 204 to close line 115B.

FIG. 3E illustrates a cross section of an embodiment of a stack of electrochemical cells in a stack of frames through the line A′-A′ in FIG. 3A. The cross section A′-A′ is transverse to the flow of electrolyte in the electrochemical cell from inlet manifolds 1, 2 to outlet manifolds 3, 4. In this embodiment, the frame 31 includes ledges 33 on which the non-permeable (negative) metal electrode 25 is seated. Additionally, the non-permeable electrode 25 of a first electrochemical cell 101a is spaced apart from and connected to the permeable (positive) electrode 23 of an adjacent, overlying electrochemical cell 101b by one or more electrically conductive spacers 18, such as metal or carbon spacers. An electrolyte flow channel 19 is thereby formed between the non-permeable electrode 25 of the first electrochemical cell 101a and the overlying permeable electrode 23 of an adjacent electrochemical cell 101b. Further, if plural conductive spacers 18 are used, then the spacers divide the electrolyte flow path 18 into a series of flow channels 19.

In an embodiment, the electrodes 23, 25 of adjacent electrochemical cells 101 are provided as an assembly 50. In this embodiment, the non-permeable electrode 25 of a first electrochemical cell 101a, the conductive spacers 18 separated by channels 19 and the porous electrode 23 of the adjacent electrochemical cell 101b are assembled as a single unit. The individual components may be glued, bolted, clamped, brazed, soldered or otherwise joined together. The fabrication of an electrode assembly 50 simplifies and speeds the assembly of stacked flow cell device. Each electrode assembly is placed into a respective frame 31, such that one electrode (e.g., the larger non-permeable electrode 25) is supported by the ledges 33 in the frame 31, and the other electrode (e.g., the smaller non-permeable electrode 23) is supported in the space 41 between the ledges 33 by the spacers 18 from the underlying non-permeable electrode 25. Of course the order of the electrodes may be reversed and the porous electrode may be supported by the ledges 33. Other electrode attachment configurations, such as bolting or clamping to the frame, may be used. The frames 31 with the electrodes 23, 25 are stacked upon each other to form the stack 103 of cells. As each frame is stacked, a new cell 101 is created with a reaction zone 32 in between the bottom electrode 23 and a top electrode 25 of each cell. As seen in FIGS. 2A-2C, the electrodes 23, 25 of the same cell (e.g., 101a) are separated by the reaction zone 32 and do not physically or electrically contact each other and comprise a portion of separate electrode assemblies.

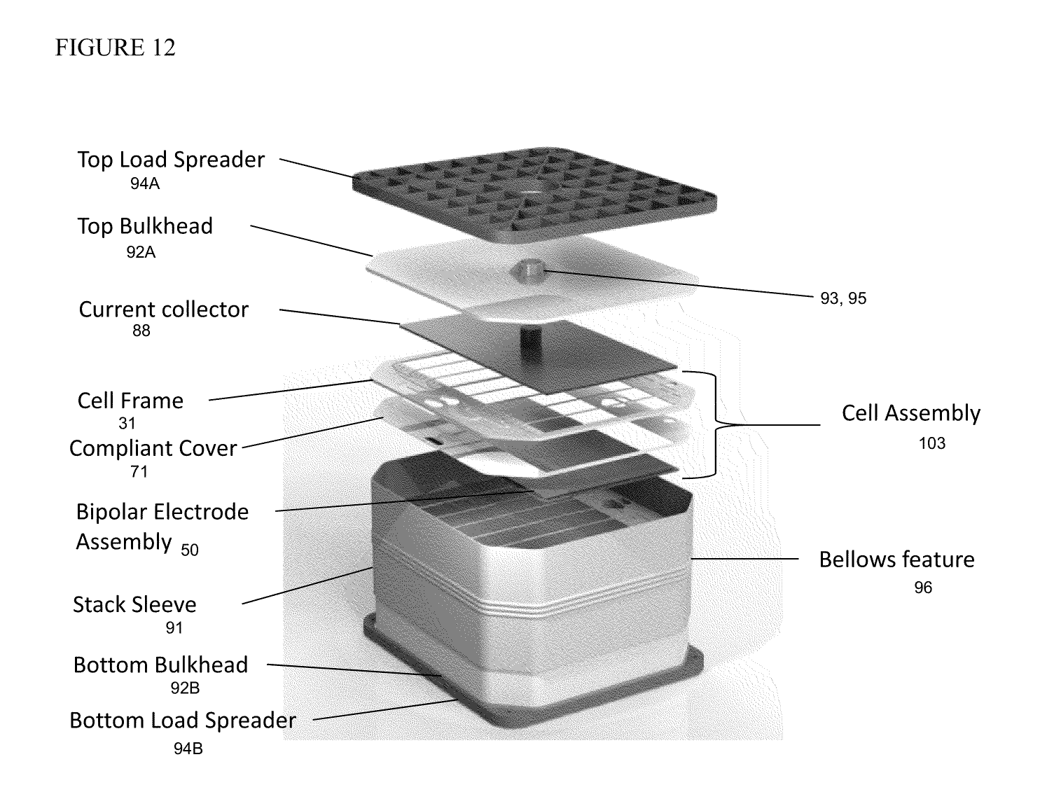

As described above, the flow battery system illustrated in FIGS. 1-3E contains two types of flow manifolds: stack manifolds 1, 2, 3 and 4 which are common flow paths that feed individual cell flow paths, and cell manifolds 40, 42, 44 and 46 which are flow paths that distribute flow from (or to) the stack manifold to (or from) the entire width of the active area in an individual flow cell. Preferably, as described above and illustrated in FIGS. 3A and 3B, the stack manifolds (e.g., aligned holes in a stack of cell frames 31) and cell manifolds (e.g., grooves in the cell frames 31) are formed directly into the cell frames 31 that house and align the electrodes in a stack assembly. This eliminates the cost and complexity associated with external manifold plumbing (e.g., large tube feeding multiple small tubes) found in prior art flow batteries. Additionally, the integration of the stack and cell manifolds into the cell frame ensures that the stack and cell manifolds are fully contained within the primary stack sealing envelope shown in FIG. 12. As a result, the flow channel seals are not integral to the seal between the stack and the vessel 102, reducing the overall leak risk.

Shunt Current Mitigation

As described above, the electrochemical flow battery system contains a stack 103 of cells 101 electrically connected in series and fed by a common supply of electrolyte in parallel. The cells in a stack are at different potentials and the conductive electrolyte in the flow manifolds provides a pathway between cells through which a shunt current can flow. A shunt current is a parasitic current conducted ionically through the electrolyte in the manifolds connecting the cells in a stack.

The shunt current can hinder the performance of the flow battery in a number of ways described below. First, the shunt current can cause cell imbalance and cumulative capacity degradation. In a charge mode, shunt currents may increase the rate of charge of the cells near the positive and negative ends of the stack relative to the rate of charge of the cells near the middle of the stack. In a discharge mode, shunt currents may increase the rate of discharge of the cells near the center of the stack relative to the rate of discharge of the cells near the positive and negative ends of the stack. The cumulative effect of this phenomenon over multiple cycles may lead to a degradation in available capacity. Second, the shunt current can cause undesirable reactions. Shunt currents, which are a flux of ions through the electrolyte connecting the electrodes in a stack, require corresponding electrochemical reactions at the electrode-to-electrolyte interfaces. These reactions may include undesirable evolution of hydrogen gas or corrosion of the electrodes. Third, shunt current can degrade system efficiency. The power loss associated with the shunt currents has a corresponding reduction in roundtrip efficiency over a single cycle. Fourth, the shunt current can cause self-discharge. In a standby mode (e.g., a mode other than charge or discharge), shunt currents may slowly discharge the stack. This may reduce the amount of capacity available after prolonged pauses between charge and discharge and may lead to the same type of imbalance described in above.

Manifold Cross-Section and Length

One embodiment of mitigating the undesirable effects of shunt currents is by selecting the cross-sectional area and length of the manifolds to increase the ionic resistance through the manifolds. This resistance may be referred to as shunt resistance. FIG. 3F schematically illustrates of the shunt current resistor network in the flow battery stack illustrated in FIGS. 1-3E. The resistors in the stack and cell manifolds are illustrated by the resistor symbol. While it is desirable to use the manifold geometry to maximize shunt current resistance (e.g. by restricting or lengthening both the stack and cell manifolds), it is also desirable to use the manifold geometry to ensure uniform distribution of flow among all the cells in the stack (e.g. by enlarging the cross-section or shortening the length of stack manifolds while restricting or lengthening the cell manifolds). As a result, it is preferable to achieve the bulk of the shunt resistance in the cell manifolds (e.g., distribution channels or grooves 40, 42, 44, 46 in the cell frame 31), where longer, more restrictive geometry is favorable for both shunt current mitigation and flow uniformity.

Generally, it is preferable to achieve high resistance in the cell manifolds by increasing length, rather than restricting cross-sectional area, since doing so will produce a smaller increase in fluidic resistance (and corresponding increase in energy loss due to pumping electrolyte) for a given increase in shunt resistance. However, increasing cell manifold length also increases the overall packaging volume of the stack, which has downstream effects on cost and energy density. Finally, the cell manifold should also distribute flow uniformly from the stack manifold to the entire width of the active area in a cell.

One way to balance the above objectives is to use a bifurcating cell manifold (40, 42, 44, 46) design, such as the one shown in FIGS. 3A and 3B. The bifurcating approach evenly distributes the flow across a wide area by dividing the flow through an increasing number of flow paths of nearly equal fluidic resistance. These somewhat circuitous paths also make it possible to package a significant length of cell manifold (i.e., high shunt resistance) in a relatively small space.

An alternative way to package a long cell manifold channel 40 is to use a non-straight cell manifold pathway, such as a serpentine pathway, illustrated in FIG. 4. Other non-straight pathway shapes include spiral, zig-zag, or other tightly packed arrangements of a long manifold channel. In an embodiment, the inlet 61 from each of the cell manifold (e.g., inlet) channels 40 into the active area 41 opening which contains the electrochemical cells includes an expansion portion 45. Portion 45 is located adjacent to the step 33 described above with respect to FIG. 3E. Portion 45 has a larger width than the remaining channel 40, and may have a continuously increasing width toward the inlet 61 (i.e., triangular shape when viewed from above). The expansion portion 45 aids in spreading the electrolyte and thereby providing a more even and laminar flow distribution of electrolyte across the electrodes 23, 25. In an embodiment, the expansion portion 45 further includes bumps or pillars 46. The bumps or pillars 46 interact with the flowing electrolyte to reduce turbulence in the inlet flow. In this manner, a smoother, more laminar electrolyte flow can be provided to the electrodes 23, 25. The same configuration may be used in the inlet 62 from inlet channels 46 on the bottom of the cell frame and the outlets 65 and 66 for outlet channels 42 and 44, respectively, as shown in FIGS. 3A and 3B.

Expanded Electrode-to-Electrolyte Interface Area

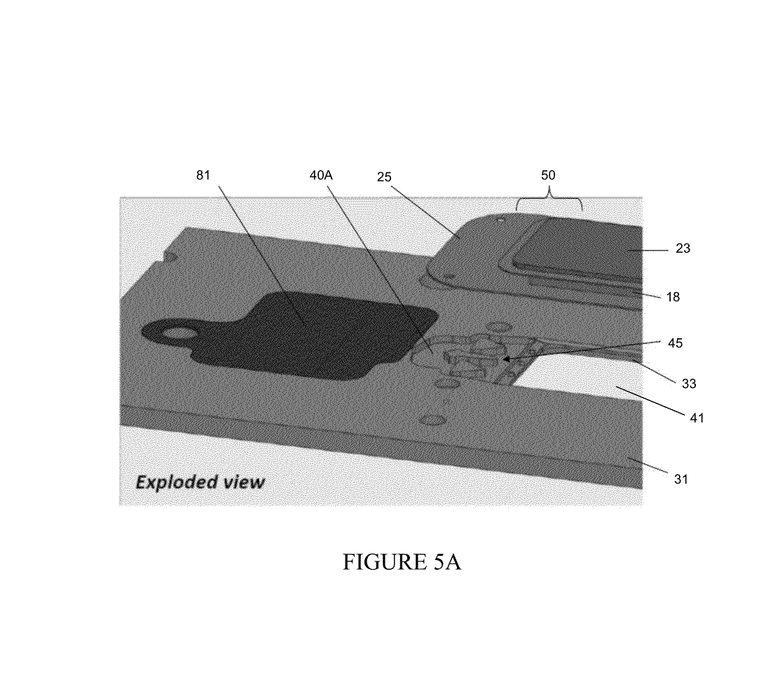

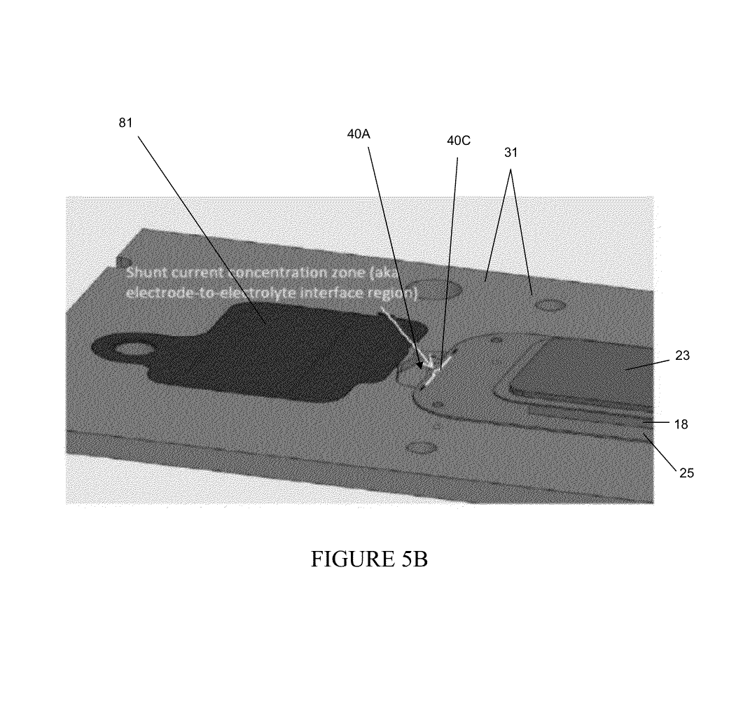

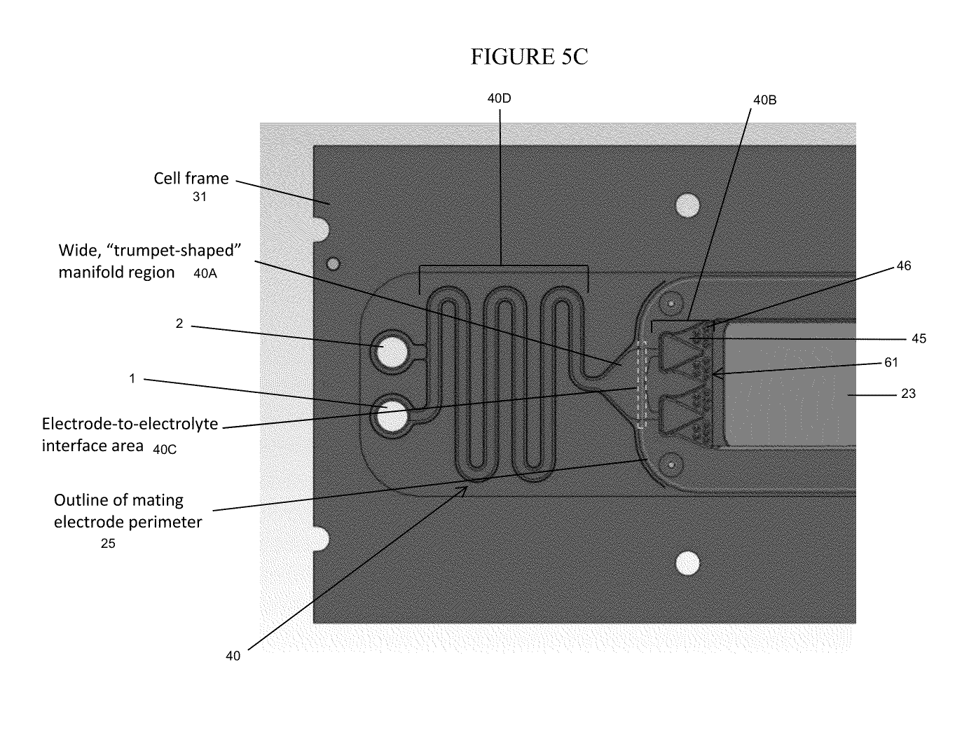

In one embodiment, the inlet distribution channel 40 (i.e., cell manifold) widens into a trumpet (e.g., triangular) shape prior to reaching the impermeable electrode 25 edge in order to maximize the electrode-to-electrolyte interface area at which shunt current reactions take place. This is shown in FIGS. 5A (exploded view), 5B (three dimensional perspective view) and 5C (partially transparent top view through the impermeable electrode) of the cell frame 31 of FIG. 4 in combination with the bipolar electrode assembly 50.

As shown in FIGS. 5A-5C, the impermeable electrode 25 in each assembly 50 has a larger major surface area than the permeable electrode 23 in the assembly 50. Thus, the impermeable electrode 25 extends over a portion of the cell frame 31 and covers the active area 41 openings in the cell frame, while the permeable electrode 23 is supported by the ribs 18 above the impermeable electrode 25 of the same assembly 50 over the active area. The impermeable electrode 25 edges rest on the ledges or steps 33 surrounding the active area 41 opening.

Furthermore, an end portion of the impermeable electrode covers an end portion 40A of the inlet distribution channel 40, the splitting node section 40B adjacent to an inlet 61 to the active area 41, and the expansion portion 45 of the inlet 61 containing the bumps 46. This can be seen in FIG. 5C, which shows the location of portion 45 through the impermeable electrode 25. The electrode-to-electrolyte interface area 40C (i.e., the strip shaped area where the electrolyte first contacts electrode 25) is located at the edge of the electrode 25 where it overlies portion 40A of channel 40 adjacent to the splitting node section 40B. Thus, the electrolyte flows from manifold 1 into the reaction zone of the cell (under the impermeable electrode in active area 41) through the beginning portion 40D of channel 40, then through the trumpet shaped end portion 40A and the adjacent electrode-to-electrolyte interface area 40C of channel 40 and finally through the expansion portion 45 of the inlet 61.

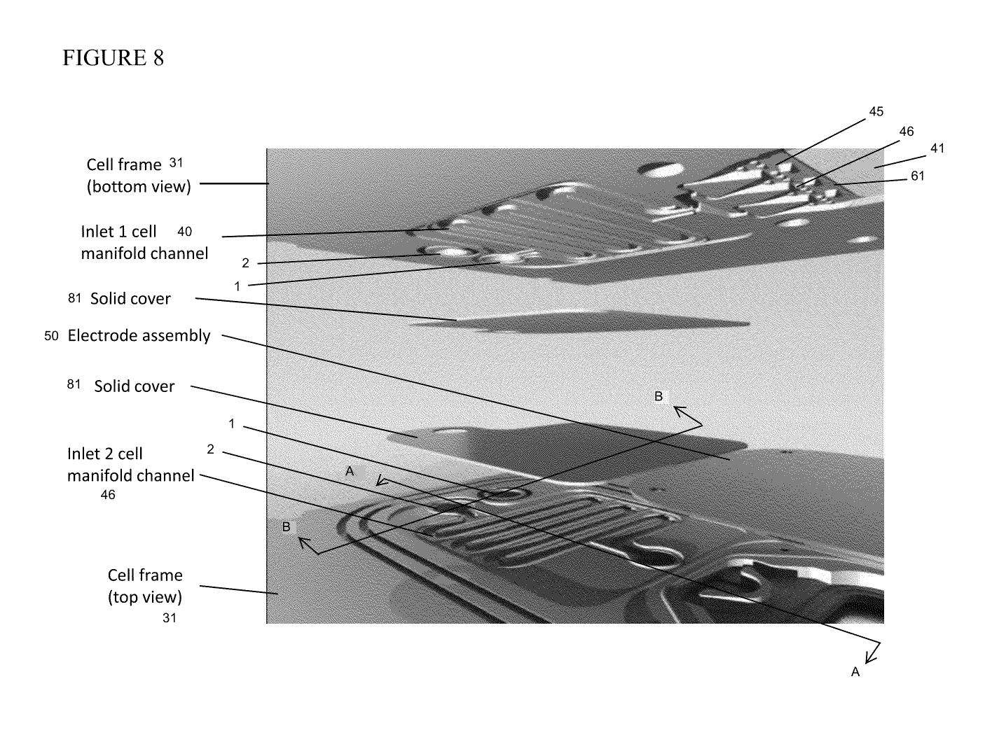

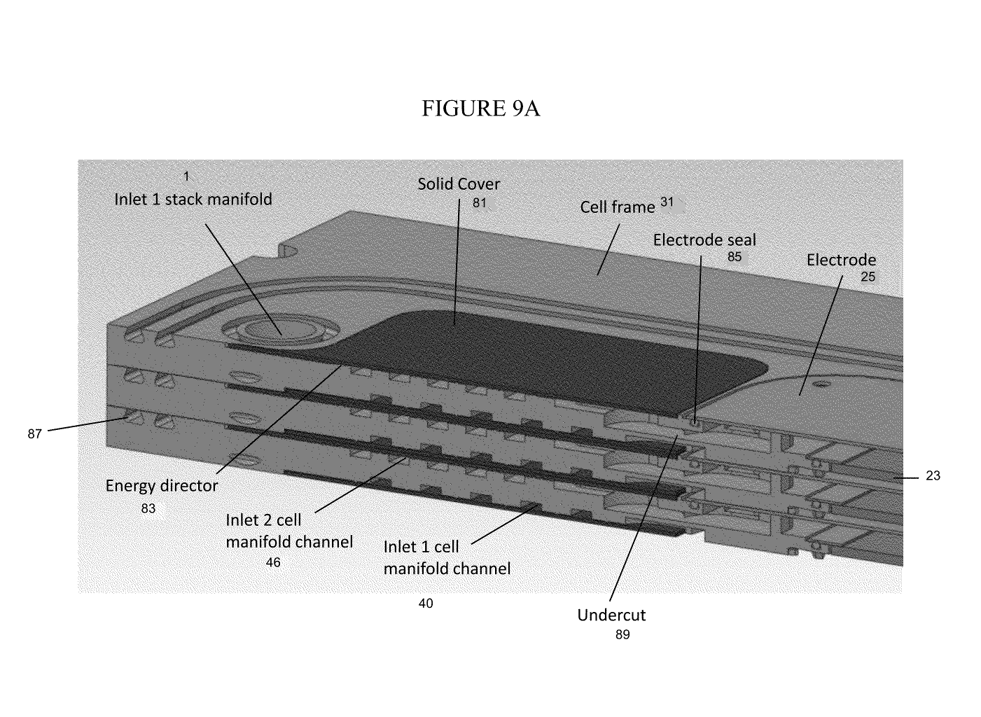

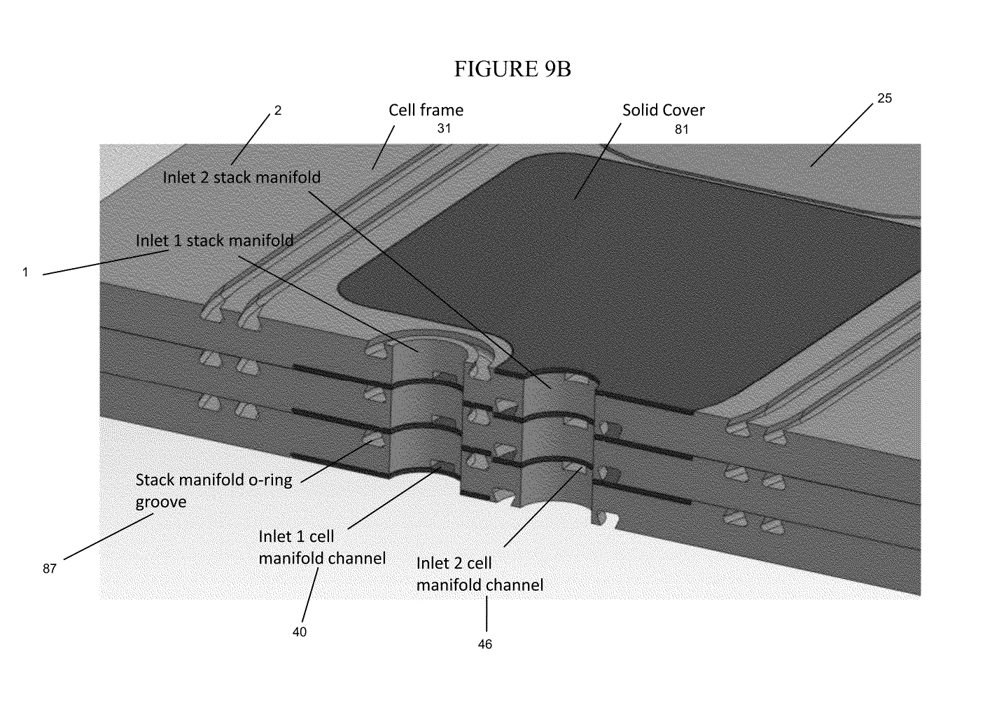

The end portion 40A of channel 40 has a larger width than the beginning portion 40D located between the end portion 40A and the stack inlet manifold opening 1 in the cell frame 31. As shown in FIG. 5C, the beginning portion 40D of the inlet distribution channel 40 comprises a serpentine channel portion between the inlet manifold opening 1 and portion 40A. The end portion 40A of the inlet distribution channel 40 has a trumpet shape which is wider than the serpentine channel portion 40D. The cover 81 shown in FIGS. 5A-5B will be discussed below with respect to FIGS. 8-9 below.

This trumped shape of region 40A increases the width of the electrode-to-electrolyte area 40C which minimizes the current density on the electrode 25, which in turn creates electrochemical conditions that favor a “passive” reaction (e.g. oxide growth) rather than an electrode corrosion reaction (e.g. titanium dissolution, in the case of a titanium electrode). In summary, the distribution channel 40 widens into a trumpet shape 40A before being overlapped by the impermeable electrode 25. This increases the region of the electrode 25 at which shunt currents will concentrate, thereby reducing the current density on the electrode 25 and reducing the likelihood of corrosion.

Distribution Channel Cover

A seal is required to ensure that the conductive electrolyte only flows through the high shunt resistance cell manifolds/distribution channels 40, 42, 44, 46 and not over or around this restrictive geometry. In other words, the seal prevents the electrolyte from flowing over the walls of the channels 40-46 in the cell frame 31. Additionally, in configurations with more than one inlet and/or outlet stack manifold 1-4, a seal is required to ensure that the flow stays within its designated flow path and doesn't move from one stack manifold to another or one side of an electrode to the other. Two embodiments of these seal designs are discussed below.

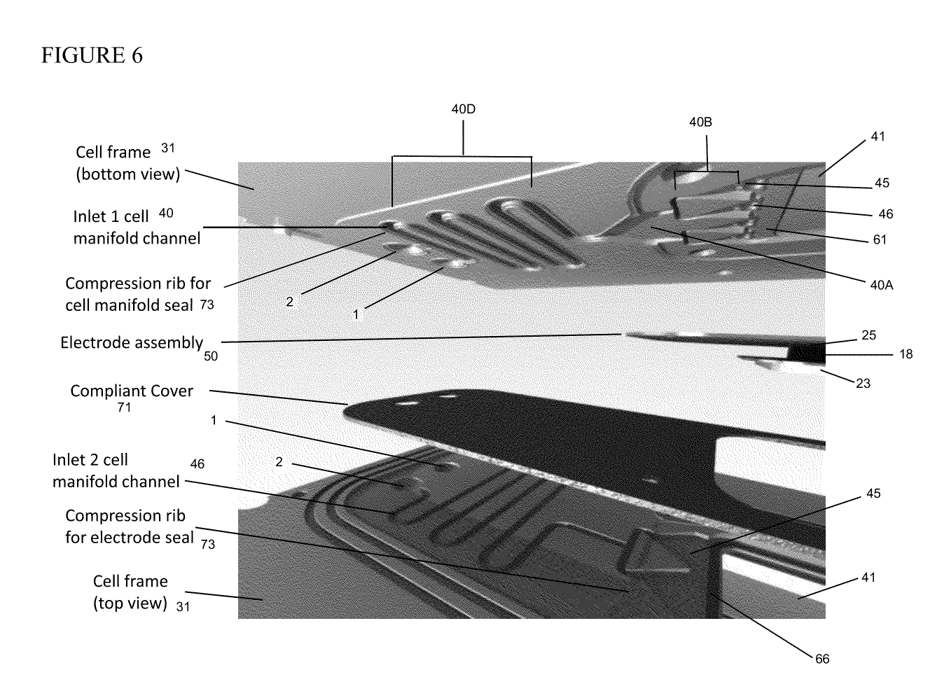

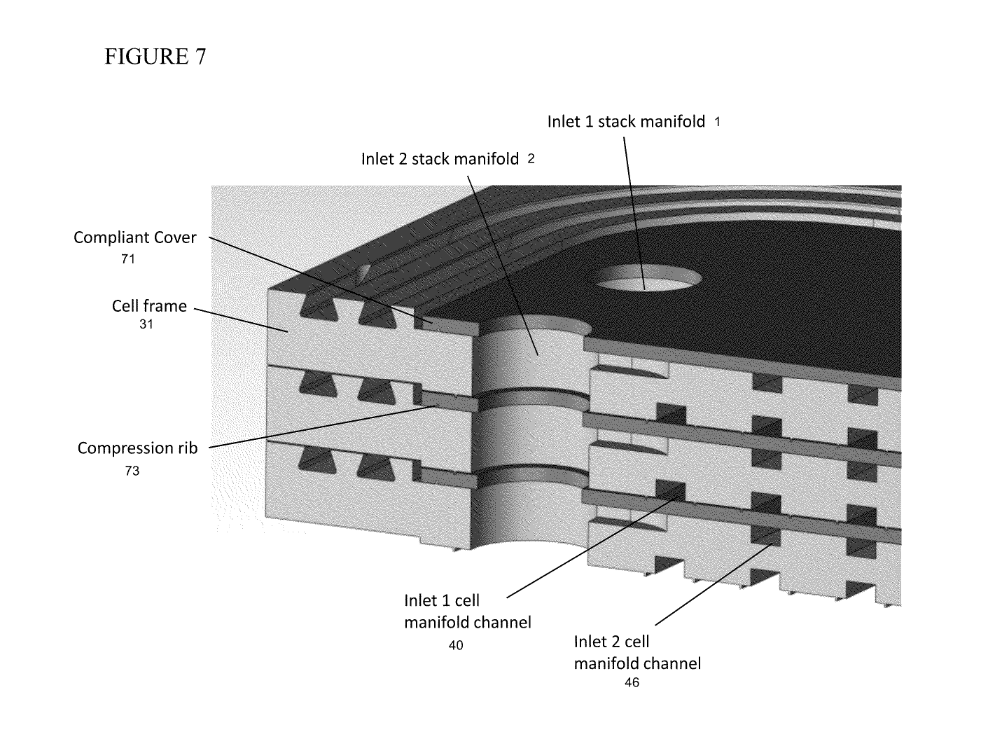

In one embodiment illustrated in FIGS. 6-7, a “compliant cover” design utilizes a cover 71 comprising a sheet of compliant or elastomeric material, such as rubber, for example Viton rubber, to cover the cell manifolds 40-46 and prevent fluid from escaping the cell manifold channels. A compliant material is a material having a low stiffness, low resistance to deformation and a relatively high value in units of compliance (i.e., meters per Newton).

The compliant or elastomeric nature of the material of the cover 71 allows it to provide a durable seal while accommodating tolerances in the cell frame 31 and electrode assembly 50. Compression ribs 73 in the cell frames 31 may be used to concentrate the compression of the compliant cover to a smaller area in order to create a robust seal where desired without the need for excessive compression forces. FIG. 6 shows an exploded view of the compliant cover 71 with compression ribs 73 on the bottom side of the cell frame 31 that follow the perimeter of the stack manifolds 1-4 and cell manifolds 40-46. FIG. 7 shows a three dimensional cut away view of the stack of FIG. 6. It should be noted that the stack elements shown in FIG. 6 are upside down with respect to the same elements shown in FIGS. 4-5 in order to more clearly illustrate the location of the ribs 73. When the stack 103 is assembled and the cells are pressed together, the compliant cover 71 deforms and seals against the compression ribs 73 of one cell frame 31 on one side and the adjacent cell frame 31 surface on the other side to ensure that flow stays within the desired manifolds 1-4, 40-46.

Thus, an upper side of the lower cell frame 31 in the stack comprises first compression ribs 73, and a lower side of an adjacent upper cell frame 31 in the stack comprises second compression ribs 73. The first and the second compression ribs 73 follow a perimeter of the cell frame stack, the inlet manifold opening(s) 1, 2, the outlet manifold openings 3, 4 and the cell manifolds 40-46. As shown in FIG. 7, the compliant cover 71 is deformed such that: (i) the compliant cover seals in its first portions against the first compression ribs on its bottom side and against the lower side of the second cell frame on its top side, and (ii) the compliant cover seals in its second portions against the second compression ribs on its top side and against the upper side of the first cell frame on its bottom side. The compliant cover may also seal against an electrode on one side and a cell from or compression rib on the other, as shown in FIG. 6.

The cover 71 is shown in FIG. 6 as covering the inlet distribution channels/inlet cell manifolds 40, 46 on opposite sides of adjacent cell frames 31 in the stack 103. However, it should be noted that the cover may instead cover the outlet distribution channels/outlet cell manifolds 42, 44 instead or in addition of the inlet distribution channels. Thus, the compliant cover 71 may be located between at least one of the inlet 40 or outlet 42 distribution channels in an upper side of the first cell frame 31 and at least one respective inlet 46 or outlet 44 distribution channel in a lower side of the second cell frame 31 located above the first cell frame in the stack of cell frames (i.e., when rotated upside down in FIG. 6). In an alternative configuration, separate covers may be used for inlet and outlet portions of the cell frame.

It should be noted that the compliant cover 71 is a separate component from any of the cell frames 31 of the stack of cell frames which support the electrodes (or separators in a battery type containing a separator in the reaction zone). In other words, the solid cover is a different component from a flat surface of one cell frame in the stack which is mated against the flow channel in an opposing surface of the adjacent cell frame in the stack.

In another embodiment illustrated in FIGS. 8, 9A and 9B, a “solid cover” design utilizes a solid sheet of material, such as plastic, to cover the cell manifolds 40-46 and prevent fluid from escaping the cell manifold channels 40-46. FIG. 8 illustrates an exploded view of the stack with the solid cover while FIGS. 9A and 9B are three dimensional cut away views along lines A-A and B-B, respectively, in FIG. 8.

As used herein, the term “solid” means non-compliant (e.g., rigid) material which has a high stiffness, high resistance to deformation and a relatively low value in units of compliance (i.e., meters per Newton). The solid cover 81 may be made of the same plastic material as the cell frame 31 or a different plastic material than the cell frame as long as the material is resistant to the metal halide electrolyte and the concentrated halogen reactant of the flow battery system.

In the case where the solid cover 81 is a compatible material with the cell frame, the cover 81 may be welded to the cell frame via ultrasonic, laser, infra-red, hot-plate, or other welding process in order to create a robust seal. For an ultrasonic welding process, it may be beneficial to include an energy director feature 83 (e.g., protrusion or rib) in the cell frame that follows the perimeter of the cell manifold channel 40-46 in order to facilitate welding in the desired locations, as shown in FIG. 9A.

Unlike the compliant cover 71 which seals against two mating cell frames and an electrode simultaneously, each solid cover 81 only seals a single cell manifold. In other words, rather than a single compliant cover 71 located between two adjacent cell frames in the stack, two solid covers 81 are located between two adjacent cell frames in the stack. One solid cover is attached to a cell manifold in the upper surface of the lower cell frame in the stack and the other solid cover is attached to a cell manifold in the lower surface of an adjacent overlying cell frame in the stack. With the solid covers in place, the remaining stack manifold 1-4 and electrode 23, 25 seals can be achieved with o-rings 85 located in grooves 87 and over the undercut region 89 as shown in FIGS. 9A and 9B.

Thus, the solid cover 81 may be attached the inlet 40, 46 and/or outlet 42, 44 distribution channels in a given side of one cell frame in the stack. The solid cover is configured to prevent electrolyte from at least one of: (i) flowing from the at least one of the inlet 40, 46 or outlet 42, 44 distribution channels in a first (e.g., upper or lower) side of the first cell frame to a respective inlet 40, 46 or outlet 42, 44 distribution channel in an opposite (e.g., lower or upper) second side of the second cell frame (where the second side faces the first side of the first cell frame in the stack of cell frames), or (ii) flowing over walls of the at least one of the inlet or outlet distribution channel.

It should be noted that the solid cover 81 is a separate component from any of the cell frames 31 of the stack of cell frames which support the electrodes (or separators in a battery type containing a separator in the reaction zone). In other words, the solid cover is a different component from a flat surface of one cell frame in the stack which is mated against the flow channel in an opposing surface of the adjacent cell frame in the stack.

Split Stack

In another embodiment, a way to reduce the magnitude of shunt currents is to “split” the stack into multiple portions, such as two portions (e.g., halves or unequal portions) such that the negative-most portion (e.g., half) of cells (cells 1 through N/2) is separated from the positive-most portion (e.g., half) of cells (cells (N/2)+1 through N) by a much higher resistance than would ordinarily be present in the small section of stack manifold connecting cell N/2 to cell (N/2)+1. As used herein, “N” refers to the number of cells in a stack and can comprise any number of cells, such as 4 to 100 cells, such as 10-30 cells. The split stack can be achieved by splitting the primary inlet and outlet conduits (e.g., manifolds, pipes and/or other fluid lines) into two conduits, one that feeds one portion of the stack (e.g., upper half of a vertical stack) and one that feeds another portion of the stack (e.g., bottom half of the vertical stack). In other words, the stack portions are electrically connected in series but fluidly connected in parallel. Thus, the stack of flow cells includes a first flow cell stack portion which is electrically connected in series to a second flow cell stack portion. The first flow cell stack portion and the second flow cell stack portion are fluidly connected in parallel to an electrolyte reservoir by at least one electrolyte inlet conduit (i.e., the electrolyte does not flow from the first stack portion to the second stack portion in series).

The distance from the top half of the stack to the bottom half of the stack through the separate inlet conduits can be made large enough (e.g. at least 1 meter long, such as 1-5 meters, for example 2 to 2.5 meters) to substantially increase the shunt resistance connecting the two portions of the stack such that the total resulting shunt currents are nearly equivalent to the shunt currents that would arise in two completely separate stacks of size N/2. This yields an overall reduction in shunt current magnitude because shunt current magnitude increases exponentially with number of cells. A simplified model of shunt currents, for example, predicts that shunt current magnitude is proportional to N². A “split” stack thus has the effect of cutting shunt currents roughly in half: i_{standard}˜N² whereas iₛₚₗᵢₜ˜(N/2)²+(N/2)²=N²/2. While the stack was described as being split into two portions which are connected electrically in series and fluidly in parallel, it should be understood that the stack may be split into more than 2 portions, such as 4, 8, 16, etc. portions (e.g., split into quarters, etc. rather than halves) as desired to mitigate shunt currents.

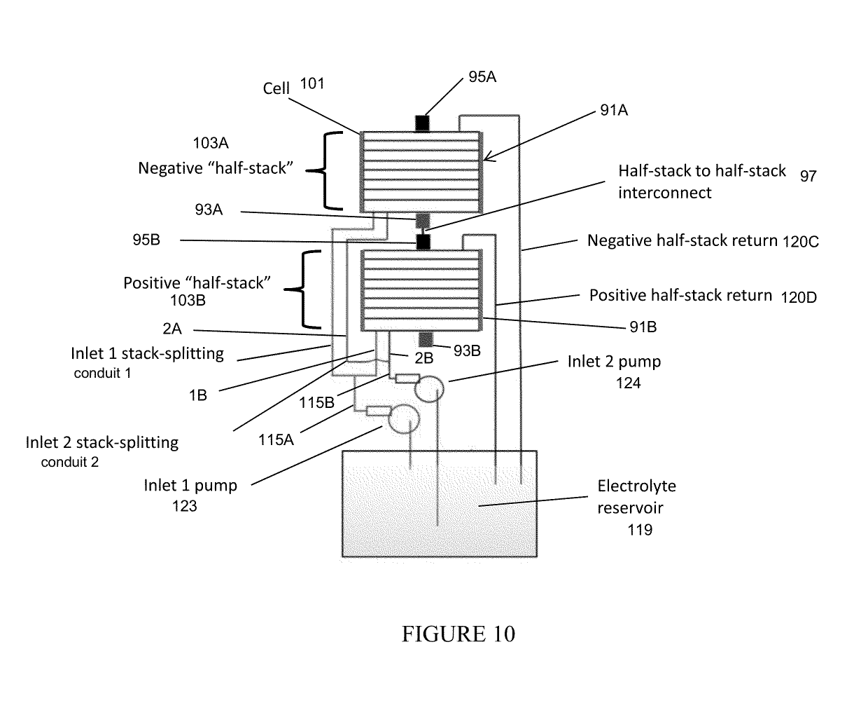

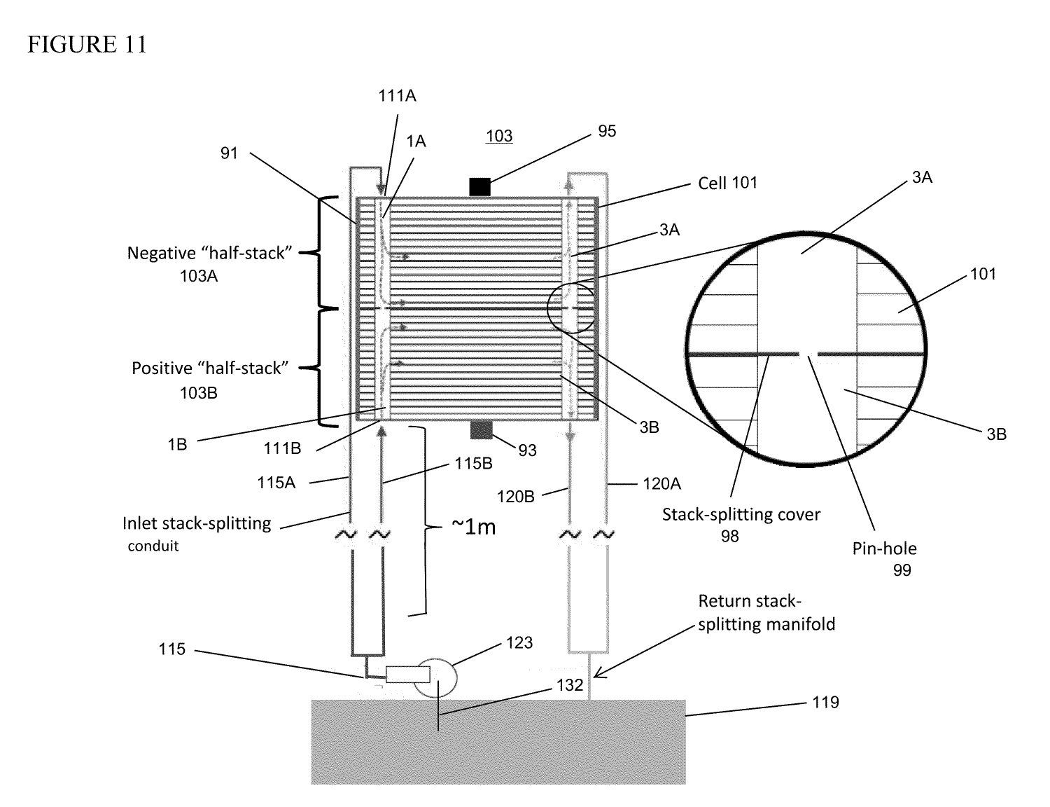

There may be several ways to split the stack into portions. For example, as described below, in one embodiment, the stack is split “externally” as illustrated in FIG. 10, and in another embodiment, the stack is split “internally” as illustrated in FIG. 11.

The internally split stack, as shown in FIG. 10, includes two separate stack portions 103A, 103B of size N/2 (e.g., each stack of flow cells has N/2 cells 101). Each stack has separate stack seals, such as separate sleeve (e.g., envelope) seals. Thus, as shown in FIG. 10, the first flow cell stack portion 103A is located in a first fluid impermeable sleeve 91A (as will be described in more detail below), and the second flow cell stack portion 103B is located in second fluid impermeable sleeve 91B which is separate from the first fluid impermeable sleeve 91A. The stack portions 103A, 103B have separate respective positive (93A, 93B) and negative (95A, 95B) stack terminals. These “half-stacks” are connected in series with an electrical interconnect 97 which connects the positive terminal 93A of the negative stack portion 103A to the negative terminal 95B of the positive stack portion 103B.

Electrolyte is supplied to/from each half-stack 103A, 103B via stack-splitting conduits from the reservoir by one or more pumps 123, 124. The conduits may comprise a first line or pipe 115A connected to a first inlet pump 123 and a second line or pipe 115B connected to a second inlet pump 124. Line 115A is connected to split manifolds (or other conduit types) 1A, 1B while line 115B is connected to split manifolds 2A, 2B. Each line 115A, 115B and manifold 1A, 1B, 2A, 2B may be similar to those (115, 1, 2) described above with respect to FIG. 2A, except for the split. In other words, manifold 1 is split into parallel (e.g., teed) manifolds 1A, 1B and manifold 2 is split into parallel (e.g., teed) manifolds 2A, 2B extending to respective stack portions 103A, 103B. Alternatively, the stack splitting conduits may be a common line that tees into two separate lines, each of which supplies one half-stack, rather than manifolds through the cells frames. Each stack portion 103A, 103B has a separate outlet or return conduit (e.g., manifold and/or line) 120C, 120D.

The split conduits (e.g., lines 115A, 115B and/or manifolds 1A, 1B, 2A, 2B) are configured such that the distance through the conduits from one half-stack to the other creates a much higher resistance than would otherwise be present in the stack manifold between two adjacent cells. The combined lengths of the two conduits (e.g., manifolds 1A and 1B) located downstream of the tee (in the inlet case) provides the shunt resistance that effectively “splits” the stack. For example, the manifolds 1A, 1B, 2A, 2B may be at least one meter long each.

In an alternative configuration, the stack splitting conduits may also be two separate lines submerged in the electrolyte reservoir, rather than two lines teed into a common line as illustrated in FIG. 10. Furthermore, rather than utilizing two separate pumps 123, 124 shown in FIG. 10, a single pump and valve(s) 204, 205 shown in FIG. 2A may be used instead for the teed conduits.

The externally split stack, as shown in FIG. 11, contains a single stack 103 with one envelope or sleeve seal 91 and one set of terminals 93, 95. This stack is separated into two half-stacks via an internal stack-splitting cover 98. The stack-splitting cover 98 blocks or restricts ionic current flow through the stack inlet and/or outlet manifolds 1A, 1B, 3A, 3B by occluding all or part of the stack manifold cross-section.

Each stack portion 103A, 103B contains a respective portion 1A, 1B of the stack inlet manifold 1. Electrolyte is supplied to the manifolds 1A, 1B in the half-stack portions 103A, 103B via separate ports 111A, 111B located at the respective top and bottom of the stack 103. The ports 111A, 111B are fluidly connected to respective conduits (e.g., lines or pipes) 115A, 115B. The conduits 115A, 115B may comprise teed conduits having a length of at least one 1 meter (e.g., 1-5 meters) which are connected to a common conduit 115 and inlet pump 123 which provides the electrolyte from the reservoir 119 through the conduits 115, 115A, 115B, ports 111A, 111B and manifolds 1A, 1B into the stack portions 103A, 103B. Each stack portion 103A, 103B contains a respective stack outlet conduit 3 portion 3A, 3B which are connected to the respective outlet conduits 120A, 120B. While the purge inlet manifold 2 and the second outlet manifold 4 are not shown in FIG. 11 for clarity, it should be understood that these manifolds can be included in the stack portions 103A, 103B and may be split by the cover 98 in a similar manner as manifolds 1 and 3.

The stack-splitting cover 98 may include a pin-hole feature 99 to prevent low or high density constituents (e.g. gas or complexed halogen) from getting trapped below or above the cover 98, respectively. The pin-hole feature 99 is large enough to allow these low and/or high density components to pass through from one conduit portion to another (e.g., between 1A and 1B, or between 3A and 3B), yet small enough to substantially limit ionic current flow. The pin-hole feature 99 may be an opening in the cover 98 having a width or diameter of 5 mm or less, such as 1-5 mm, e.g., 3 mm diameter. The internal split configuration may reduce cost and improve manufacturability compared to the external split approach since there are fewer parts and seals.

In general, in the internal and external split stack configurations, various conduit configurations may be used. For example, at least one circulation pump 123 is configured to convey a flow of the electrolyte from the reservoir 119 to the stack 103 of flow cells through the inlet pipe or line 115 and the inlet manifold (e.g., stack inlet manifold 1). The inlet line 115 may comprise a common stem portion (e.g., 132) extending into the reservoir 119, a first branch portion 115A fluidly connecting the stem portion 132 with the inlet manifold 1A in the first flow cell stack portion 103A, and a second branch portion 115B fluidly connecting the stem portion 132 with the inlet manifold 1B in the second flow cell stack portion 103B, as shown in FIG. 11. Alternatively, the inlet line 115 comprises a first portion 115A extending between the reservoir 119 and the inlet manifold 1A in the first flow cell stack portion 103A, and a second portion 115B extending between the reservoir 119 and the inlet manifold 1B in the second flow cell stack portion 103B, as shown in FIG. 11.

Stack Seal

As discussed above and as illustrated in FIG. 12, a fluid impermeable sleeve seal 91 is located around the stack 103 of cell frames 31 supporting the flow cells 101. The sleeve seal (e.g., envelope seal) is configured to prevent electrolyte from leaking outside the stack of cell frames through an outer side of the stack of cell frames. Thus, the stack manifold and cell manifold seals illustrated in FIGS. 9A and 9B can be entirely contained within the primary sleeve seal (i.e., stack sealing envelope) 91, minimizing the number of potential leak points. As shown in FIG. 12, the stack sleeve seal 91 may be formed by installing a plastic sleeve around the stack 103 and welding or otherwise sealing this sleeve to bulkheads 92A, 92B and load spreaders 94A, 94B at the top and bottom of the stack 103. Alternatively, the stack elements (e.g., cell frames 31, electrodes 23, 25, etc.) may be sequentially stacked inside the sleeve followed by the welding or sealing step. The advantage of this approach is a significant reduction in manufacturing cycle time and leak risk as opposed to a more traditional approach of sealing one cell to another and/or supplying fluid to each cell with an external manifold. As shown in FIG. 12, the stack sleeve seal 91 may include a formed bellows 96 feature in order to accommodate creep, compression, or swelling of the stack over time and/or during assembly. A current collector 88 connected to an electric terminal 93 or 95 at the top of the stack 103 is also shown in FIG. 12.

Alternative Flow Configurations

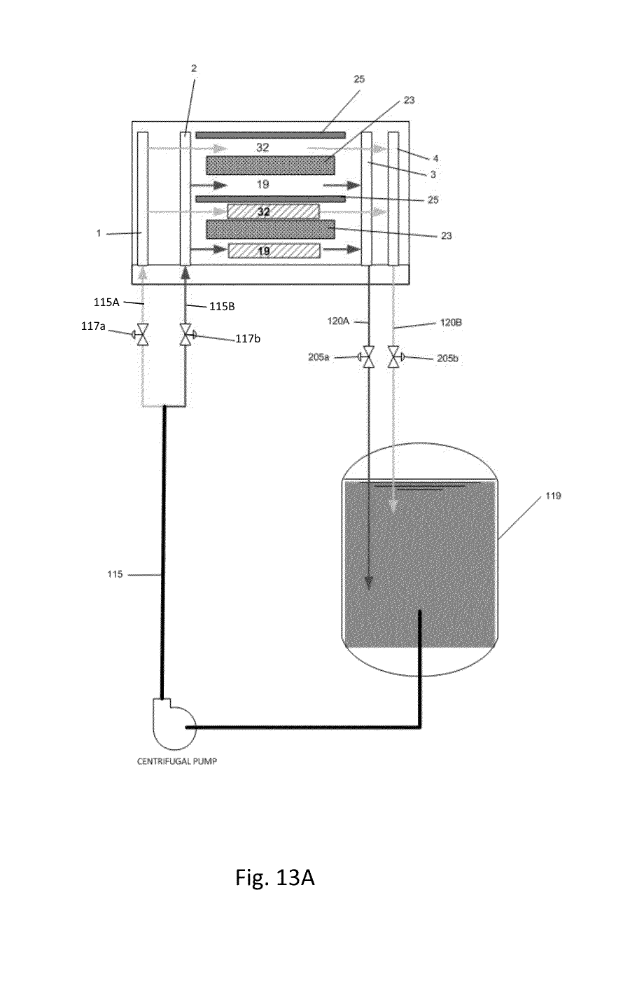

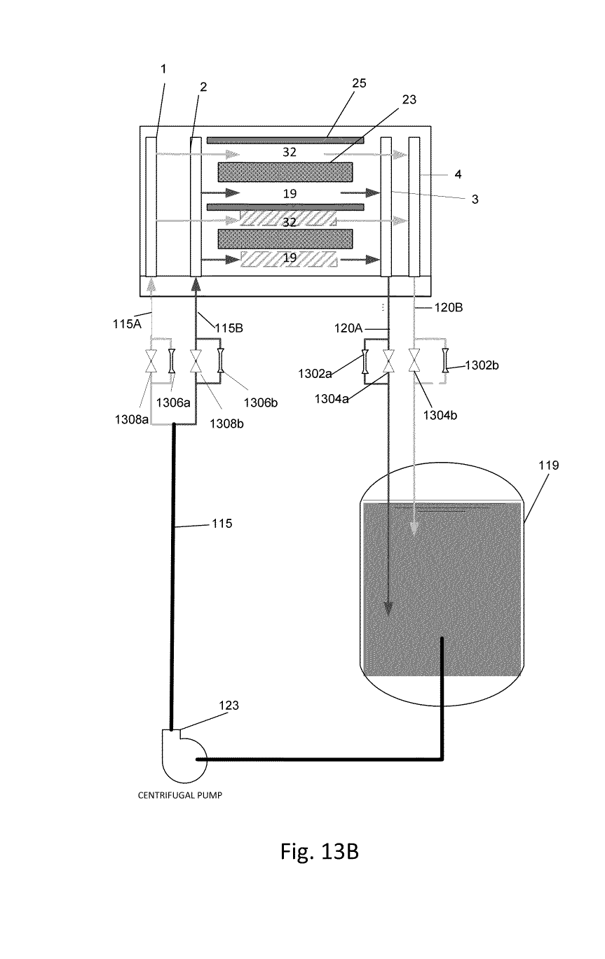

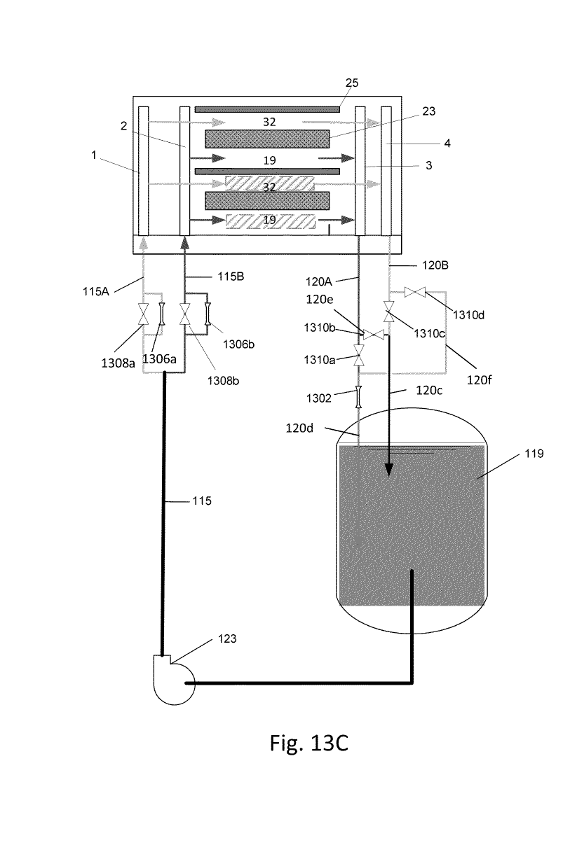

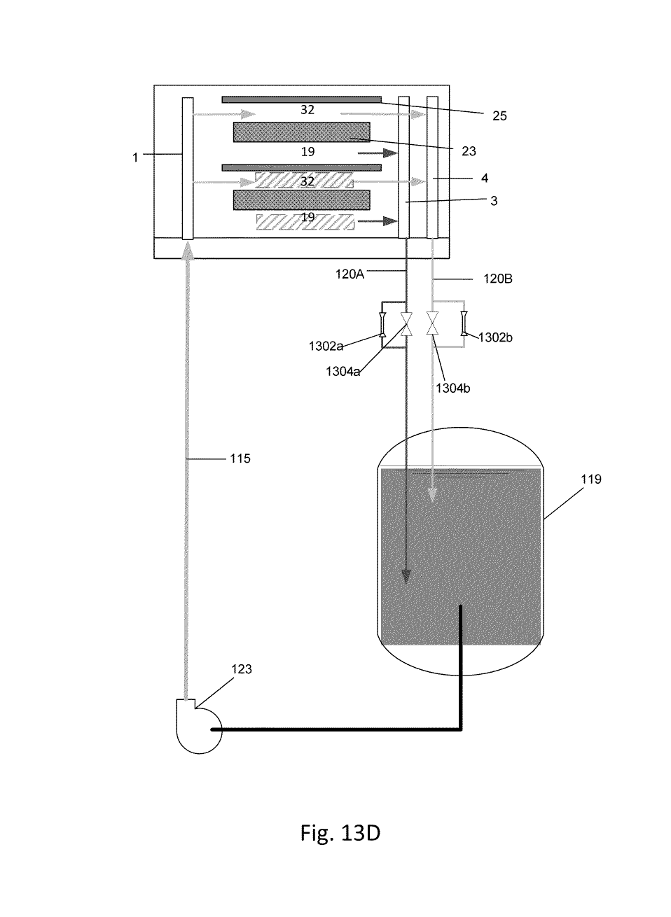

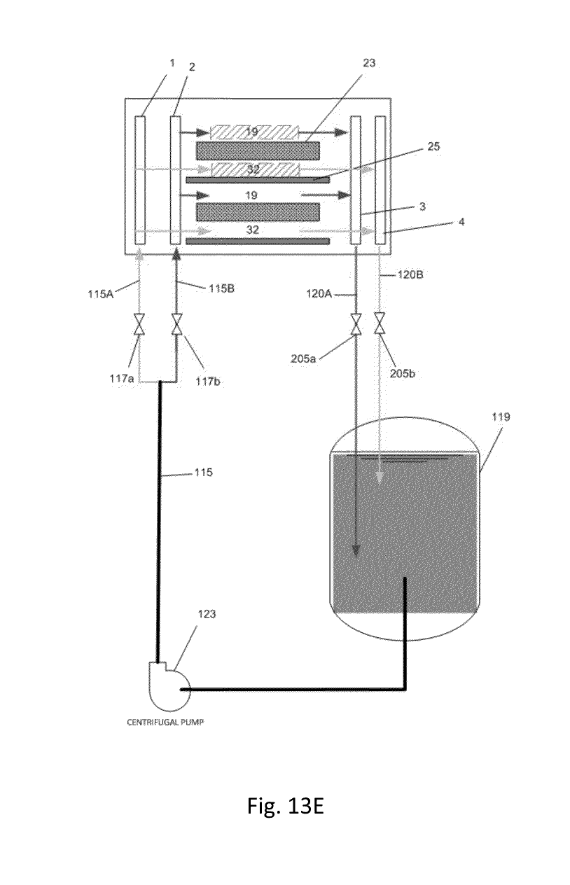

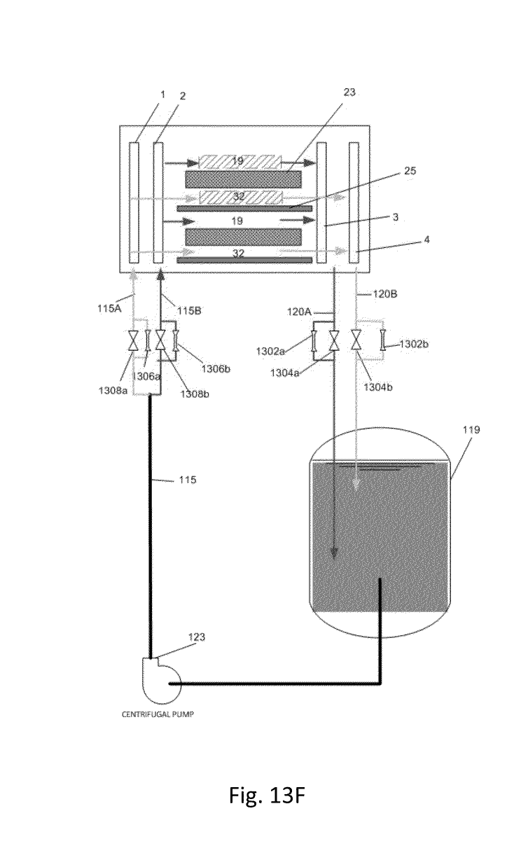

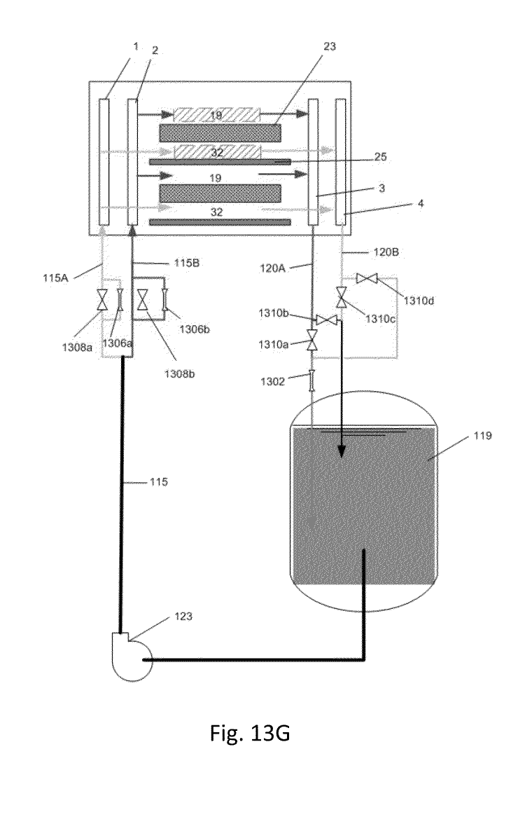

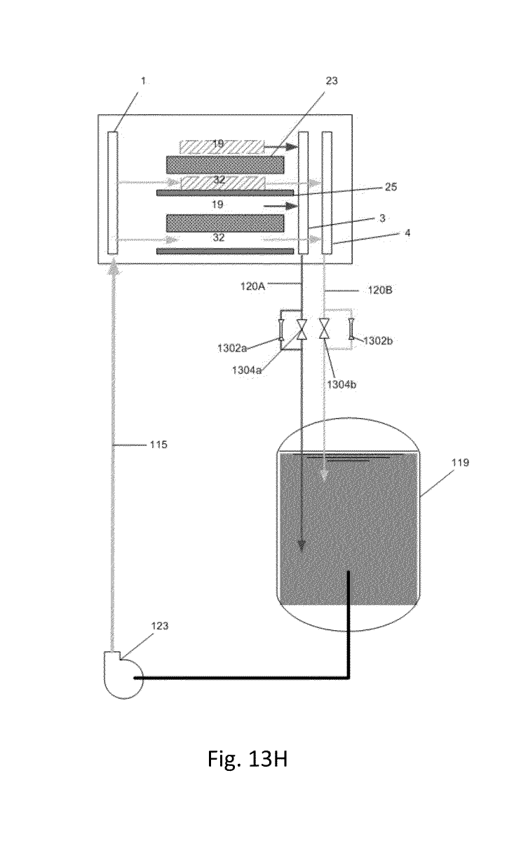

FIGS. 13A-13D schematically illustrate alternative flow paths for a flow of the metal-halide electrolyte and the halogen reactant through the horizontally positioned cells of a stack, such as the stack 103 of FIGS. 1 and 2A. The electrolyte flow paths in FIGS. 13A-13D are represented by arrows. For brevity, and in order to allow comparison with the electrolyte flow paths previously discussed, components illustrated in and discussed above with respect to FIGS. 2A-2C, are identified in FIGS. 13A-13D with the same reference numerals.

In an alternative embodiment shown in FIG. 13A, manifold 3 provides the electrolyte into conduit 120A while manifold 4 provides the electrolyte into conduit 120B. Conduits 120A and 120B separately provide outlet (i.e., exit) flow streams to the reservoir 119, and have separate flow control valves 205a and 205b, respectively (instead of the three way valve 205 in FIG. 2A). In this manner, the tendency of the complex halogen to settle out and collect in the discharge exit path in conduit 120A may be avoided. That is, preserving the concentrated stream of complex halogen and returning it to a separate location may enable easier storage and management of the complex phase. Also, to control the flow ratios of the main inlet line and purge inlet line, conduits 115A and 115B may be configured with control flow valves 117a and 117b, respectively. If the majority of the flow enters the main inlet conduit 115A in all operational modes, then flow control valve 117a may be eliminated.

In another alternative embodiment, shown in FIG. 13B, conduits 120A and 120B separately provide exit flow streams to the reservoir 119, similar to the embodiment discussed above with respect to FIG. 13A. In this embodiment, however, conduits 120A and 120B may be configured with calibrated pipe restrictions 1302a, 1302b and on/off valves 1304a, 1304b, in order to control the flow ratios of the exit flow streams. Also, to control the flow ratios of the main inlet line and purge inlet line, conduits 115A and 115B may be configured with calibrated pipe restrictions 1306a, 1306b and on/off valves 1308a, 1308b. The pipe restrictions comprise a narrow pipe or orifice that has a smaller width or diameter than conduits 120A, 120B. If the majority of the flow enters the main inlet conduit 115A in all operational modes, then flow control valves 117a, 117b and restriction 1306a may be eliminated to leave only the restriction 1306b.

In another alternative embodiment, shown in FIG. 13C, the output conduits 120A, 120B may be fluidly connected to a majority outlet flow conduit 120c and a minority outlet flow conduit 120d. The majority of the outlet (i.e., exit) flow always flows through conduit 120c in both charge and discharge modes, while the minority of the outlet flow flows through conduit 120d in both charge and discharge modes. A calibrated pipe restriction 1302 is located in conduit 120d but not in conduit 120c. On/off valves 1310a, 1310b, 1310c and 1310d may be used to steer the outlet (i.e., exit) flows from manifolds 3 and 4 through various conduits 120a-120d into the reservoir 119.

In this configuration, the exit flow return locations are differentiated by flow rate, rather than the flow path from which they originated. For example, in charge mode, the majority of the outlet flow flows from reaction zone 32, through manifold 4, into conduit 120B, while the minority of the outlet flow or no outlet flow flows from region 19 through manifold 3 into conduit 120A. In charge mode, on/off valves 1310a and 1310c are open and valves 1310b and 1310d are closed. This valve configuration forces the minority of the outlet flow to travel from region 19 through manifold 3, conduit 120A, valve 1310a and through the calibrated pipe restriction 1302 in conduit 120d to the reservoir, while the majority of the outlet flow travels from reaction zone 32 through manifold 4, conduit 120B, valve 1310c and conduit 120c into the reservoir.

In the discharge mode, the valve configuration is reversed, on/off valves 1310a and 1310c are closed and valves 1310b and 1310d are open. This valve configuration forces the minority of the outlet flow to travel from the reaction zone 32 through manifold 4, conduit 120B, valve 1310d, bypass conduit 120f and through the calibrated pipe restriction 1302 in conduit 120d to the reservoir, while the majority of the outlet flow travels from region 19 through manifold 3, conduit 120A, valve 1310b, bypass conduit 120e and conduit 120c into the reservoir. Thus, in both modes, the majority of the flow bypasses the restriction 1302 while the minority of the flow flows through the restriction.

While four on/off valves are illustrated in FIG. 13C, multi-way valve(s) may be used instead to direct the flows between conduits 120A, 120B and conduits 102C and 120D. This arrangement of FIG. 13C may be preferable if there is a device downstream of the stack that operates best under specific flow conditions.

In another alternative embodiment, shown in FIG. 13D, the main inlet is provided by conduit 115, through which electrolyte may flow from the reservoir 119 to the manifold 1. In contrast to other embodiments discussed herein, no purge inlet or inlet flow control valve is provided in this embodiment configuration. Thus, conduit 115B and manifold 2 are omitted in this embodiment and there is only one common inlet conduit 115 and inlet manifold 1 for both charge and discharge modes. Conduits 120A and 120B may be configured with calibrated pipe restrictions 1302a, 1302b and on/off valves 1304a, 1304b, in order to control the flow ratios of the exit flow streams, similar to the embodiment described above with respect to FIG. 13B. Valve 1304a is closed and valve 1304b is open in charge mode. In contrast, valve 1304a is open and valve 1304b is closed in discharge mode. Thus, fixed restriction should be sufficient to control the amount of flow going into each outlet path, in which allows the use of pair of cheaper on/off valves rather than a more costly flow control valve.

FIGS. 13E-13H schematically illustrate alternative embodiments corresponding to the embodiments shown in FIGS. 13A-13D, respectively. In each of FIGS. 13E-13H, the upper electrode in each cell is a permeable electrode 23, and the lower electrode in each cell is an impermeable electrode 25, whereas FIGS. 13A-13D show the opposite electrode configuration. In contrast to the Zn plating in FIGS. 13A-13D, which occurs on the bottom face of impermeable electrode 25 against gravity, in FIGS. 13E-13H, the plating of Zn occurs on the top face of impermeable electrode 25. All other features in FIGS. 13E-13H are similar to FIGS. 13A-13D. Of course the alternative electrode configuration described above for FIGS. 13E-13H may also be used in the system shown in FIG. 13A.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A flow battery, comprising:
a stack of flow cells, wherein each flow cell comprises:
at least one fluid permeable electrode;
at least one fluid impermeable electrode; and
a reaction zone between the permeable and impermeable electrodes;
a stack of cell frames supporting the stack of cells, the stack of cell frames comprising a first cell frame located adjacent to a second cell frame;
a inlet manifold opening and a outlet manifold opening in each cell frame in the stack of cell frames;
a inlet manifold formed by aligned inlet manifold openings in the stack of cell frames;
a outlet manifold formed by aligned outlet manifold openings in the stack of cell frames;
at least one inlet distribution channel and at least one outlet distribution channel located in each cell frame, wherein the inlet distribution channel is configured to introduce an electrolyte from the inlet manifold to the reaction zone of each cell, and the outlet distribution channel is configured to introduce the electrolyte from the reaction zone to the outlet manifold; and
at least one sealing or shunt current mitigation feature comprising at least one of:
(a) a first portion of the inlet distribution channel covered by a portion of the impermeable electrode has a larger width than a second portion of the inlet distribution channel located between the first portion and the inlet manifold opening in the cell frame;
(b) a compliant cover located between at least one of the inlet or outlet distribution channels in an upper side of the first cell frame and at least one respective inlet or outlet distribution channel in a lower side of the second cell frame located above the first cell frame in the stack of cell frames;
(c) a solid cover attached over at least one of the inlet or outlet distribution channels in a first side of the first cell frame, wherein the solid cover is configured to prevent electrolyte from at least one of (i) flowing from the at least one of the inlet or outlet distribution channels in the first side of the first cell frame to a respective at least one of the inlet or outlet distribution channels in a second side of the second cell frame which faces the first side of the first cell frame in the stack of cell frames, or (ii) flowing over walls of the at least one of the inlet or outlet distribution channel;
(d) a fluid impermeable sleeve located around the stack of cell frames, wherein the sleeve is configured to prevent electrolyte from leaking outside the stack of cell frames through an outer side of the stack of cell frames; or
(e) the stack of flow cells comprises a first flow cell stack portion which is electrically connected in series to a second flow cell stack portion, wherein the first flow cell stack portion and the second flow cell stack portion are fluidly connected in parallel to an electrolyte reservoir by at least one electrolyte inlet conduit.

2. The flow battery of claim 1, wherein:
the permeable electrode comprises porous ruthenized titanium;
the non-permeable electrode comprises titanium that is coated with zinc during the charge mode; and
the stack of flow cells comprises a vertical stack of horizontally positioned flow cells.

3. The flow battery of claim 1, wherein the inlet distribution channel comprises a splitting node section adjacent to an outlet from the inlet distribution channel to a respective flow cell, each splitting node configured to split a flow of the electrolyte into two.

4. The flow battery of claim 3, wherein the at least one shunt current mitigation feature comprises feature (a).

5. The flow battery of claim 4, wherein:
the second portion of the inlet distribution channel comprises a serpentine channel portion between the inlet manifold opening and the splitting node section;
the first portion of the inlet distribution channel has a trumpet shape which is wider than the serpentine channel portion.

6. The flow battery of claim 1, wherein the at least one shunt current mitigation feature comprises feature (b).

7. The flow battery of claim 1, wherein:
an upper side of the first cell frame comprises first compression ribs;
a lower side of the second cell frame comprises second compression ribs;
the first and the second compression ribs follow a perimeter of the cell frame stack, the inlet manifold opening and the outlet manifold opening; and
the compliant cover is deformed such that:
(i) the compliant cover seals in its first portions against the first compression ribs on its bottom side and against the lower side of the second cell frame on its top side, and
(ii) the compliant cover seals in its second portions against the second compression ribs on its top side and against the upper side of the first cell frame on its bottom side.

8. The flow battery of claim 1, wherein the at least one shunt current mitigation feature comprises feature (c).

9. The flow battery of claim 8, wherein:
the solid cover is welded to the upper surface of the first cell frame over the inlet distribution channel; and
the solid cover comprises a separate component from any frame of the stack of cell frames.

10. The flow battery of claim 1, wherein the at least one sealing feature comprises feature (d).

11. The flow battery of claim 10, wherein the sleeve contains a bellows and the sleeve is sealed to bulkheads at the top and bottom of the stack of cell frames.

12. The flow battery of claim 1, wherein the at least one shunt current mitigation feature comprises feature (e) and wherein the inlet conduit has a length of at least one meter.

13. The flow battery of claim 12, wherein:
the first flow cell stack portion is located in a first fluid impermeable sleeve; and the second flow cell stack portion is located in second fluid impermeable sleeve which is separate from the first fluid impermeable sleeve.

14. The flow battery of claim 12, wherein:
both the first and the second flow cell stack portions are located in the same fluid impermeable sleeve; and
the first and the second flow cell stack portions are separated by an internal stack-splitting cover which is configured to block or restrict ionic current flow through the inlet and the outlet manifolds by occluding all or part of the inlet and the outlet manifold cross-section.

15. The flow battery of claim 14, wherein the stack-splitting cover includes a pin-hole over at least one of the inlet or outlet manifold.

16. The flow battery of claim 12, further comprising:
an electrolyte storage reservoir located below the stack of flow cells; and
a circulation pump a configured to convey a flow of the electrolyte from the reservoir to the stack of flow cells through the inlet conduit and the inlet manifold.

17. The flow battery of claim 16, wherein the inlet conduit comprises:
a common stem portion extending into the reservoir;
a first branch portion fluidly connecting the stem portion with the inlet manifold in the first flow cell stack portion; and
a second branch portion fluidly connecting the stem portion with the inlet manifold in the second flow cell stack portion.

18. The flow battery of claim 16, wherein the inlet conduit comprises:
a first portion extending between the reservoir and the inlet manifold in the first flow cell stack portion; and
a second portion extending between the reservoir and the inlet manifold in the second flow cell stack portion.

19. The flow battery of claim 1, wherein the at least one sealing or shunt current mitigation feature comprises at least two features selected from features (a) through (e).

20. The flow battery of claim 19, wherein the at least one sealing or shunt current mitigation feature comprises sealing feature (d) and shunt current mitigation features (a), (e) and one of feature (b) or feature (c).

21. The flow battery of claim 1, wherein the flow battery comprises a single flow loop hybrid flow battery having a single electrolyte reservoir and no separator or ion exchange membrane in the reaction zone between the permeable and impermeable electrodes.

22. A method of operating a flow battery, comprising:
(i) flowing a metal halide electrolyte from a reservoir through a inlet manifold to a stack of flow cells supported by a stack of cell frames using at least one inlet distribution channel in each cell frame in the stack of cell frames;
(ii) flowing the electrolyte from the stack of flow cells through a outlet manifold to the reservoir using at least one outlet distribution channel in each cell frame in the stack of cell frames; and
performing at least one shunt current mitigation step during at least one of step (i) or step (ii);
wherein:
each flow cell comprises:
at least one fluid permeable electrode;
at least one fluid impermeable electrode; and
a reaction zone between the permeable and impermeable electrodes;
the stack of cell frames comprises a first cell frame located adjacent to a second cell frame;
each cell frame in the stack of cell frames comprises a inlet manifold opening and a outlet manifold opening;
the inlet manifold is formed by aligned inlet manifold openings in the stack of cell frames;
the outlet manifold formed by aligned outlet manifold openings in the stack of cell frames; and
the at least one shunt current mitigation step comprises at least one of:
(a) contacting the electrolyte to an exposed portion of the impermeable electrode of at least one flow cell covering a first portion of the inlet distribution channel of at least one cell frame, wherein the first portion of the inlet distribution channel has a larger width than a second portion of the inlet distribution channel located between the first portion and the inlet manifold opening in the cell frame;
(b) flowing the electrolyte on at least one side of a compliant cover located between at least one of the inlet or outlet distribution channels in an upper side of the first cell frame and a respective at least one of the inlet or outlet distribution channels in a lower side of the second cell frame located above the first cell frame in the stack of cell frames;
(c) flowing the electrolyte on at least one side of a solid cover attached over at least one of the inlet or outlet distribution channels in a first side of the first cell frame, wherein the solid cover prevents at least one of: (i) electrolyte from flowing from the at least one of the inlet or outlet distribution channels in the first side of the first cell frame to a respective at least one of the inlet or outlet distribution channels in a second side of the second cell frame which faces the first side of the first cell frame in the stack of cell frames, or (ii) flowing over walls of the at least one of the inlet or outlet distribution channel; or
(e) flowing the electrolyte from the reservoir in parallel to a first flow cell stack portion and a second flow cell stack portion, and providing or collecting current in series from the first flow cell stack portion and the second flow cell stack portion.
